(19) United States
(12) Patent Application Publication
(10) Pub. No.: US 2003/0235481 A1
(43) Pub. Date: Dec. 25, 2003

(54) Torque indicator

(76) Inventors: Matthew J. Dunfee, Chaska, MN (US); Donald G. Chase, Jordan, MN (US); David A. Gosewisch, Jordan, MN (US); Donald W. Hegeman, Shakopee, MN (US); David D. Schneider, Hamburg, MN (US); Timothy J. Walker, Minetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/401,120

(22) Filed: Mar. 27, 2003

Related U.S. Application Data
(63) Continuation-in-part of application No. 10/307,259, filed on Nov. 29, 2002, now abandoned.
Application No. 10/307,259 is a continuation-in-part of application No. 09/941,152, filed on Aug. 27, 2001, now abandoned.
(60) Provisional application No. 60/227,892, filed on Aug. 25, 2000.

(51) Int. Cl. F16B 31/00

(52) U.S. Cl. 411/3

(57) ABSTRACT

A torque lock/indicator including first and second members and a compression ring for sealingly contacting a surface of the first member. The first member has first and second contact surfaces and structure for generally axially accommodating a connector. The second member has a ring member and a plurality of extensions extending from the ring member, each extension has an angled first contact surface and a second contact surface proximate the first contact surface. The connector is tightened until the compression ring is compressed to a predetermined degree. As the compression ring is being compressed the first member first contact surface is slidingly displaced against the second member contact surface. When the connector has been tightened to a predetermined level of torque, the first member first contact surface has been displaced past the second member first contact surface and the first member second contact surface strikes the second member second contact surface generating a mechanical vibration. The first member optionally has a generally cylindrical member to accommodate the connector. An optional cap is provided which is secured to the cylindrical member to detect that the tightened connector has been tampered.

### CROSS-REFERENCES TO RELATED APPLICATIONS

This application is a continuation-in-part of U.S. patent application Ser. No. 10/307,259, filed 29 Nov. 2002, which, in turn, is a continuation-in-part of U.S. patent application Ser. No. 09/941,152, filed 27 Aug. 2001, which, in turn, claims priority under 35 U.S.C. §119 (e) to U.S. Provisional Application No. 60/227,892, filed 25 Aug. 2000, each of the foregoing U.S. patent applications hereby incorporated by reference.

### BACKGROUND OF THE INVENTION

1. Field of the Invention

This invention relates to safety devices and, in particular, this invention relates to devices which ensure that correct torque levels are applied to connectors.

2. Background of the Invention

Ensuring that a correct level of torque is applied to connectors can be of critical importance. One instance where applying the correct level of torque is critically important is when engine oil is changed. Typically, the oil plug is removed from the reservoir drain, the oil is allowed to flow from the reservoir, the oil plug is replaced, and new oil is poured into the engine. Overtightening oil plugs can strip the threads from the reservoir drain, thereby causing oil leakage and engine damage. Undertightening oil plugs can cause oil leakage and engine damage as well. While torque wrenches can correctly tighten oil plugs, they are seldom used.

Another issue frequently encountered is leakage itself. After the oil plug has been replaced, oil leaks can arise due to an insufficient seal resulting from improperly tightening the oil plug, from worn components no longer sealing, or from failure to use a seal. The oil leaked from engines onto surfaces pollutes and fouls floors of buildings and soils and, thereby necessitates cleanup protocols that generate materials which are themselves hazardous to the environment. Oil leaked onto floors is itself a hazard. Oil spots may cause injuries to workers by causing the workers to slip and/or fall when encountering surfaces made slippery by leaked oil. Oil may also cause fires by increasing the combustibility of oil-soaked materials. Leaked oil is also an environmental hazard. For example, oil leaked onto soil is resistant to natural decomposition and, if leaked in sufficient quantities, may sterilize areas for appreciable periods of time.

Still another frequently arising issue is prevention and detection of tampering of oil plugs. Often it is desirable to seal the oil plug after an oil change has been performed. Sealing the oil plug serves to deter or detect tampering and can ensure that only authorized persons have serviced the engine.

There is then a need for a device which will ensure that a correct amount of torque is applied to a fastener, which will provide a fluid-tight seal, which can subsequently be easily removed, and which provides a seal to deter and detect the presence of tampering.

### SUMMARY OF THE INVENTION

This invention substantially meets the aforementioned needs by providing a torque lock/indicator and seal.

An embodiment of the present torque lock/indicator includes an upper (first) member, a compression ring, a lower (second) member, and an optional encloser cap. The upper member has a cylindrical element, at least three (e.g., up to 12) legs depending from the cylindrical element, and a substantially planar element disposed at one end of the cylindrical element. An angled contact surface is present on each leg distal to the attachment of the leg to the cylindrical element and a locking surface near the contact surface is present. The lower member has a structure with a substantially peripheral contact surface and a locking surface proximate the contact surface. The compression ring is disposed between the upper and lower (threaded hole mating surfaces) members. The upper member, compression ring, and lower member are configured to axially and rotationally receive a fastener, such as a bolt or an oil plug, therethrough. As the fastener is tightened, the upper member contact surfaces are slidingly displaced against the lower member contact surface and the legs are biased outwardly. When a predetermined level of torque has been applied to the fastener, the upper member contact surfaces have been displaced past the lower member contact surface, thereby allowing the legs to return toward an unbiased position and interlocking the upper and lower members by contacting the upper member and lower member locking surfaces. An optional cap either interlocks with the upper or lower member or is cemented into place. The cap can only be removed by destroying its integrity.

Another embodiment of the present torque lock/indicator includes a first member, a second member, and a compression member. The first member may define a bore and may include a sealing surface and first and second contact surfaces. The bore may be dimensioned and disposed to accommodate a shaft of the connector therewithin. The first contact surfaces may be angularly disposed with respect to the second contact surface. The second member may include a ring element and a plurality of extensions, the extensions extending from the ring element in an unbiased position and having first and second contact surfaces. Each second member extension first contact surface may be angularly disposed with respect to each corresponding second member extension second contact surface. The compression member may be substantially disposable within the second member ring element and may define a bore, the bore accommodating the fastener shaft such that the compression member sealingly contacts the first member sealing surface. When the present torque lock/indicator is in a first disposition, the first member first contact surface may slidingly contact the second member first contact surface as the fastener is being tightened and as the compression member is being compressed to outwardly bias each of the second member extensions. When the fastener has been tightened to a predetermined torque level, the first member first contact surface has been displaced past the second member first contact surface to release each extension from the unbiased position, such that the second member second contact surface strikingly contacts the first member second contact surface to generate a mechanical vibration. The mechanical vibration, in turn, may generate an audible sound and may be tactilely sensed as well. Additionally, when the connector has been tightened to a predetermined torque level, the second member extensions engage the first member such that the second member may be freely rotated. Visual indications that the connector has been tightened to a predetermined torque level are the return of the second member extensions to unbiased positions and the ability to freely rotated the second member. The first member, second member, and compression ring may be connected in a preassembled embodiment. In an other embodiment the first member may be configured in the head of a fastener.

It is an object of this invention to provide a torque indicator to ensure that only a predetermined torque level will be applied to a fastener.

It is another object of this invention to provide a torque indicator which ensures that threaded openings will not be damaged by over tightening of fasteners being threaded therein.

It is yet still another object of this invention to provide a torque indicator which provides a means of ensuring that threads of openings are functional under known torque levels.

It is a feature of the present invention to provide a device which will emit an audible signal when a predetermined amount of torque has been applied to a fastener.

It is another feature of the present invention to provide a device which will visually indicate that a predetermined amount of torque has been applied to a fastener.

It is yet another feature of the present invention to provide a device which will vibrationally indicate that a predetermined amount of torque has been applied to a fastener.

It is still another feature of the present invention to provide a device which includes a seal against fluid loss when the fastener has been threaded into an opening.

It is yet still another feature of the present invention to provide a device which will indicate that sufficient torque has been applied to reach a maximum of a predetermined torque range.

It is still yet another feature of the present invention to provide a device which has a tamper-resistant or tamper-indicating structure restricting access to an enclosed fastener or indicating that the enclosed fastener has been accessed.

There is also provided a torque-indicating device for use with a threaded fastener and a threaded opening, comprising:

a first member defining a bore and including a sealing surface and first and second contact surfaces, the bore accommodating a shaft of the fastener therewithin, the first contact surface disposed at an acute angle with respect to the second contact surface;

a second member including a ring element and a plurality of extensions extending from the ring element, each of the extensions in an unbiased position and displaying first and second contact surfaces, each of the first contact surfaces disposed at an acute angle with respect to one of the second contact surfaces; and

a compression member disposable within the second member ring element, with a bore accommodating the fastener shaft, and configured to sealingly contact the first member sealing surface,

the first member first contact surface slidingly contacting the second member first contact surface in a first disposition when the fastener is being threaded into the threaded opening to compress the compression member and outwardly bias each of the second member extensions, the first member first contact surface displaced past the second member first contact surface in a second disposition as the fastener is further threaded into the threaded opening such that each of the second member extensions returns to the unbiased position and such that the first member second contact surface strikingly contacts the second member second contact surface to generate a mechanical vibration when a predetermined amount of torque as been exerted on the fastener.

There is also provided the preceding torque-indicating device, in which the first member is affixed to at least one of the compression ring and the second member.

There is also provided the preceding torque-indicating device, in which the first member, second member, and compression ring are attached in a preassembled relationship.

There is also provided the preceding torque-indicating device, in which the first member accommodates a head portion of the fastener. There is also provided the preceding torque-indicating device, in which the second member is rotatably fixed to the first member when the torque-indicating device is in the second disposition. There is also provided the preceding torque-indicating device, in which the mechanical vibration generates an audible sound.

There is also provided the preceding torque-indicating device,

further comprising a cap,

the first member further comprising a generally cylindrical element accommodating an upper portion of the fastener therewithin and sealingly accommodating the cap.

There is also provided the preceding torque-indicating device, in which the first member cylindrical element defines a groove and the cap includes a bead, the groove accommodating the bead when at least a portion of the cap is disposed in the first member cylindrical element.

There is also provided the preceding torque-indicating device, in which each of the second member extensions extends generally orthogonally with respect to the ring element when each of the second member extensions is in the first disposition. There is also provided the preceding torque-indicating device, each of the second member extensions comprising an inwardly extending lip displaying one of the second member first contact surfaces and one of the second contact surfaces.

There is also provided the preceding torque-indicating device, in which the first member first compression surface tapers toward the first member sealing surface.

There is also provided torque-indicating device for use with a fastener, the fastener with a threaded fastener shaft and a fastener head, the fastener head with a larger diameter than the fastener shaft and a contact surface proximate the fastener shaft, the device comprising:

first and second members axially accommodating the fastener shaft therethrough, the first member displaying a contact surface configured to contact the fastener head contact surface and a sealing surface;

a compression member axially accommodating the fastener shaft and to sealingly contacting the first member sealing surface; and

means for indicating that a predetermined amount of torque has been exerted on the fastener head.

There is also provided the preceding torque-indicating device, in which the torque-indicating means comprises a first surface disposed on the first member and a first surface disposed on the second member, the first member first surface engaging the second member second surface when a first amount of torque has been exerted on the fastener.

There is also provided the preceding torque-indicating device, in which the torque-indicating means further comprises a second surface disposed on the first member and a second surface disposed on the second member, the second member second surface striking the first member second surface when the predetermined amount of torque has been exerted on the fastener head.

There is also provided the preceding torque-indicating device, in which the torque-indicating means further comprises a ring member and a plurality of legs extending from the ring member, each of the plurality of legs displaying the second member first and second surfaces.

There is also provided the preceding torque-indicating device, in which each of the plurality of legs extends generally orthogonally from the ring member in an unbiased position.

There is also provided the preceding torque-indicating device, further comprising means for indicating a tampering event.

There is also provided the preceding torque-indicating device, in which the tampering event indicating means comprises a generally cylindrical member extending from a peripheral portion of the first member-contact surface.

There is also provided the preceding torque-indicating device, in which the tampering event indicating means comprises a cap sealingly accommodated by the cylindrical member.

There is also provided a process for making a torque-indicating device for use with a threaded fastener with a fastener head and a threaded opening accommodating the threaded fastener, the device comprising:

forming a compression member;

forming a first member with a generally axial bore accommodating the threaded fastener, a surface for contacting the fastener head, a sealing surface for sealingly contacting the compression member, and first and second contact surfaces;

forming a second member with a ring member and a plurality of extensions extending from the ring member, the ring member accommodating the threaded fastener, each of the extensions displaying first and second contact surfaces, the first member first surface slidingly contacting each second member first contact surface when the fastener is being threaded into the opening, each of the second member contact surfaces strikingly contacting the first member contact surface when a predetermined amount of torque has been applied to the fastener.

There is also provided the preceding process, in which forming the first member includes forming a generally cylindrical member for accommodating the fastener head.

There is also provided the preceding process, further comprising forming a sealing element accommodated by the cylindrical member.

There is also provided the preceding process, in which the first member is formed so that the first member first contact surface tapers toward the first member sealing surface.

There is also provided a torque-indicating device for use with a fastener being threaded into an opening, comprising:

a first member defining a first member bore to axially accommodate the fastener, displaying a first member contact surface, and comprising a first member structure comprising a first member contact surface and a first member locking surface, the first member locking surface disposed at a first acute angle with respect to the first member contact surface;

a second member defining a second member bore to axially accommodate the fastener and comprising a second member structure comprising a plurality of second member contact surfaces and a plurality of second member locking surfaces, each of the second member locking surfaces disposed at a second acute angle with respect to one of the second member contact surfaces; and

a compression ring defining a compression ring bore axially accommodating the fastener and dimensioned for abutting contact with the first member contact surface,

the compression ring being compressed as the fastener is threaded into the opening and as the first member contact surface slidingly contacts the second member contact surface in a first position, the compression ring being further compressed as the fastener is further threaded into the opening and as the second member structure is displaced away from the first member structure and from a generally vertical unbiased position into an non-vertical biased position, the compression ring being still further compressed as the fastener is further threaded into the opening to a predetermined torque level and the first member contact surface is displaced past the second member contact surface, thereby allowing the second member structure to return to the generally vertical unbiased position and bringing the first member locking surface and the second locking surface into an abutting relationship.

There is also provided the preceding torque-indicating device, the second member structure comprising a plurality of extensions, one of the plurality of second member contact surfaces and one of the plurality of second member locking surfaces being displayed on each of the plurality of extensions.

There is also provided the preceding torque-indicating device, in which the second member is rotatable relative to the first member when the fastener is threaded into the opening at said predetermined torque level.

There is also provided the preceding torque-indicating device, further comprising a cap affixable to the first member.

There is also provided the preceding torque-indicating device, in which the first member includes a first member groove and the cap includes a bead dimensioned and positioned to accommodate the first member groove.

There is provided a torque-indicating device for use with a threaded fastener, comprising:

a first member axially accommodating the fastener;

a second member axially accommodating the fastener; and

means for indicating that a predetermined level of torque has been applied to the fastener.

There is also provided the preceding torque-indicating device, in which the torque indicating means is at least partially operatively disposed between the first and second members.

There is also provided the preceding torque-indicating device, in which the torque indicating means comprises a compression ring and structure displaying a plurality of opposed contact surfaces and a plurality of opposed locking surfaces.

There is also provided the preceding torque-indicating device, in which the torque indicating means comprises a plurality of extensions, each of said plurality of extensions displaying one of said contact surfaces and one of said locking surfaces.

These and other objects, features, and advantages of this invention will become apparent from the description which follows, when considered in view of the accompanying drawings.

### BRIEF DESCRIPTION OF THE DRAWINGS

FIG. 1 is an exploded view of a first embodiment of the present torque lock/torque indicator;

FIG. 2 is a top plan view of the fork of the embodiment depicted in FIG. 1;

FIG. 3 is a bottom plan view of the fork of the embodiment depicted in FIG. 1;

FIG. 4 is a cross-sectional view of the fork of FIG. 3 along line F-F;

FIG. 5 is a top plan view of the compression ring of FIG. 1;

FIG. 6 is a cross-sectional view of the compression ring of FIG. 5 along line A-A;

FIG. 7 is a top plan view of the base of FIG. 1;

FIG. 8 is a cross-sectional view of the base of FIG. 7 along line A-A;

FIG. 9 is a magnified view of a portion of the base of FIG. 8 and designated therein as section B;

FIG. 10 is a bottom plan view of the cap of FIG. 1;

FIG. 11 is a cross-sectional view of the cap of FIG. 10 along line A-A;

FIG. 12 is an enlarged view of a second embodiment of the present torque lock/torque indicator;

FIG. 13 is a bottom plan view of a third embodiment of the present fork;

FIG. 14 is a cross-sectional view of the fork of FIG. 13 along line C-C;

FIG. 15 is a top perspective view of a fourth embodiment of the present fork;

FIG. 16 a bottom perspective view of the fork of FIG. 15;

FIG. 17 is a top plan view of the fork of FIG. 15;

FIG. 18 is a bottom plan view of the fork of FIG. 15;

FIG. 19 is a cross-sectional view of the fork of FIG. 18 along line F-F;

FIG. 20 is a magnified view of a portion of the fork of FIG. 19 and designated therein as section L;

FIG. 21 is a magnified view of a portion of the fork of FIG. 19 and designated therein as section M;

FIG. 22 is a magnified view of a portion of the fork of FIG. 19 and designated therein as section K;

FIG. 23 is an exploded view of a fifth embodiment of the present torque lock/torque indicator;

FIG. 24 is a view of a cross section of the torque lock/torque indicator of FIG. 23;

FIG. 25 is a perspective view of the torque lock/torque indicator of FIG. 23 assembled prior to use;

FIG. 26 is a perspective view of the torque lock/torque indicator of FIG. 23 after being used to indicate a predetermined torque on a connector;

FIG. 27 is a fragmentary cross section of the torque lock/torque indicator of FIG. 23 depicting an alternate surface configuration for the upper member and compression ring;

FIG. 28 is a sixth embodiment of the present torque lock/torque indicator;

FIG. 29 is a seventh embodiment of the present torque lock/torque indicator;

FIG. 30 is an eighth embodiment of the present torque lock/torque indicator;

FIG. 31 is an exploded perspective view of a ninth embodiment of the present torque lock/torque indicator;

FIG. 32 is another exploded perspective view of a ninth embodiment of the present torque lock/torque indicator;

FIG. 33 is a cross sectional view of an upper member of the torque lock/torque indicator of FIG. 31; and

FIG. 34 is an assembled version of the upper member and cap of the torque lock/torque indicator of FIG. 31.

It is understood that the above-described figures are only illustrative of the present invention and are not contemplated to limit the scope thereof.

### DETAILED DESCRIPTION

Any references to such relative terms as top and bottom, upper and lower, horizontal and vertical, inner and outer, or the like, are intended for convenience of description and are not intended to limit the present invention or its components to any one positional or spatial orientation. All dimensions of the components in the attached figures may vary with a potential design and the intended use of an embodiment of the invention without departing from the scope of the invention. All documents discussed or referenced are hereby incorporated by reference.

U.S. Pat. No. 3,595,124, issued to Lindstrand 27 Jul. 1971, discloses a controlled torque bolt having a threaded shank and a driving head adapted to shear off the bolt upon the application of a predetermined torque by a driver on the driving head. Although ensuring that a correct level of torque is applied, once tightened, the bolt conceivably cannot be easily removed.

U.S. Pat. No. 4,068,555, issued to Volkman on Jan. 17, 1978, discloses an inherently torque-limited nut, including a nut body having an internal shank-receiving threaded opening to engage a mating thread on a shank. A drive ring is held to the nut body by engagement means and includes inherent limiting means which limits the torque which can be applied to the drive ring by failing at a predetermined torque. However this device would be relatively costly to make and difficult to use, e.g., as an oil plug due to its mechanical complexity. Moreover, a tamper-proof seal is not disclosed as well.

U.S. Pat. No. 4,408,936, issued to Williamson 11 Oct. 1983, discloses a torque-limited threaded locking fastener and method for setting the same. The fastener comprises an externally threaded shank and an internally threaded collar. At least one convolution of the threads on the shank is non-circular. The collar has a nut section and a drive section. The driven section is shaped to be engaged by a driver. Between these sections there is formed a shear section having the least torque resistance of the sections. The shear section fractures when a predetermined torque is exerted between the two sections. While ensuring that a predetermined amount of torque will be applied, subsequent removal of the fastener is problematic and there is no provision to prevent or detect tampering.

U.S. Pat. No. 3,434,379, issued to Wing 25 Mar. 1969, discloses an inherently torque-limited fastener, which has a driving ring that separates from the threaded driven body upon the application of a predetermined torque to the driving ring, thereby leaving the driven body installed at the predetermined torque level. Again, this fastener ensures that a predetermined torque will be applied. However, subsequent removal of the fastener is problematic and there is no provision to detect or deter tampering.

U.S. Pat. No. 6,079,923, issued to Ross et al. 27 Jun. 2000, discloses a hybrid, or captive, panel fastener. The fastener includes a retractable screw having a thermal plastic cap molded around its head. The cap includes a slotted skirt with resilient fingers. When the retractable screw is forced downward through the bore of the ferrule having divergent sides, the fingers of the cap are spread apart by wedging action against the outside surface of the ferrule, thus providing a biasing force urging the screw in an upward retracted direction. The ends of the cap fingers include inward facing ribs which fall into a circumferential groove about the outside surface of the ferrule adjacent its bottom end. The groove may further include a plurality of radial extending teeth, which engage inward facing protrusions located on the fingertip ribs to resist unwanted loosening of the screw. Hence, the fastener of Ross et al., inter alia, fails to provide a visual, audible, or tactile indicator when a predetermined torque has been applied to the retractable screw.

U.S. Pat. No. 3,030,996, issued to Doerr 24 Apr. 1962, discloses a locknut having tension indicating spring means having a multiple-part locknut with an interchangeable spring element. The spring element is interposed between upper and lower parts of the mechanism. The resilient element is made of a shape and dimensions so that, when the locknut is being tightened and a torque of a certain desired strength has been produced, the resilient element will normally prevent such torque from being exceeded. Therefore, the locknut of Doerr fails to provide a plurality of visual indicators and totally fails to provide auditory or tactile indicators when a predetermined level of torque has been applied. The locknut of Doerr further fails to provide a seal against fluid egress when the locknut has been properly tightened.

French Patent Publication 2 421 300 assigned to Michelin (1979) discloses a vehicle wheel-fixing device having a screw (or nut) and a washer. The washer is disclosed as being elastic in the axial direction and having an outer axial extension in the opposite direction to that in which it is to be compressed when tightened. The extension has a device at the end thereof engaging the nut or screw on the washer, when compressed for an amount representing the degree to which tightening must take place. Hence, the wheel-fixing device of Michelin fails to provide a plurality of visual indicators or a single audible or tactile indicator that a desired amount of torque has been applied to the screw or nut.

Representative examples of the teachings of the present invention, which examples utilize many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, specific combinations of features and methods disclosed in the following detailed description may not be necessary to practice the invention, and are instead taught merely to particularly describe representative and preferred embodiments of the invention. A person of ordinary skill in the art will readily recognize that each component of an embodiment of the present torque lock/torque indicator can be easily adapted to be used with other components of other embodiments.

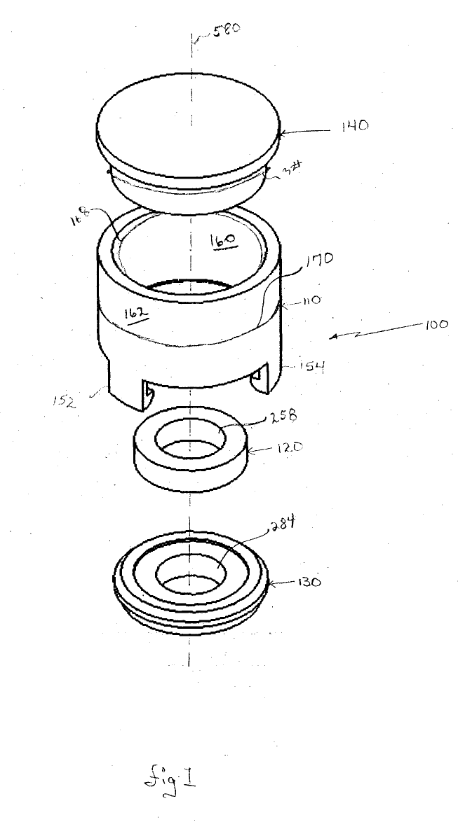

An exploded view of one embodiment of the present torque lock/torque indicator is shown in FIG. 1 generally at 100 and includes an upper (first) member such as a fork 110, a compression member such as a ring 120, a lower (second) member such as a base 130, and an optional tamper proof mechanism such as a cap 140.

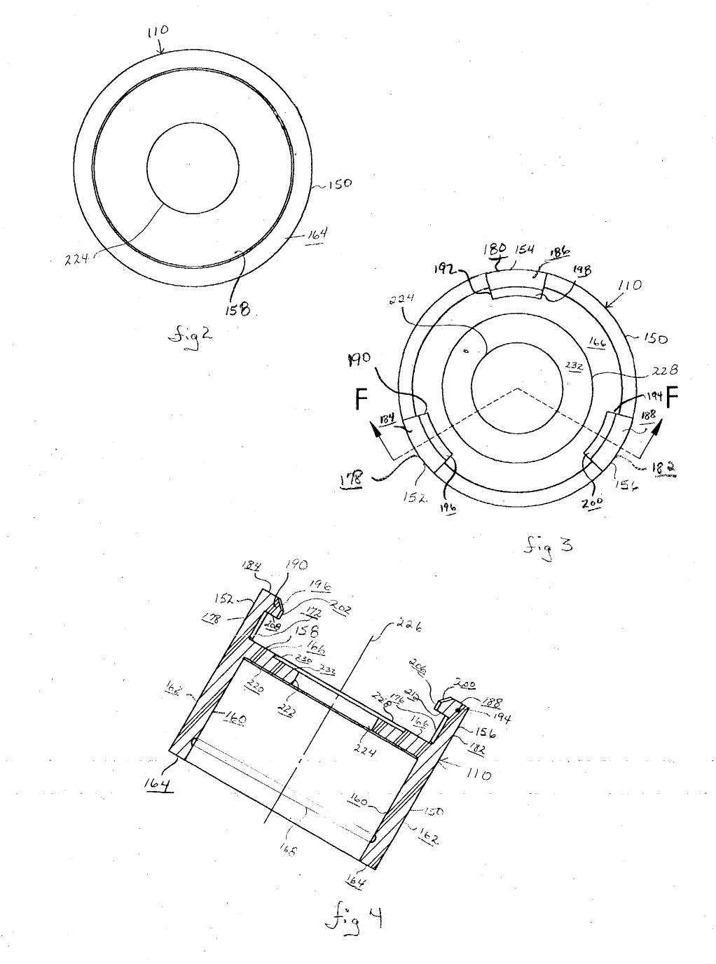

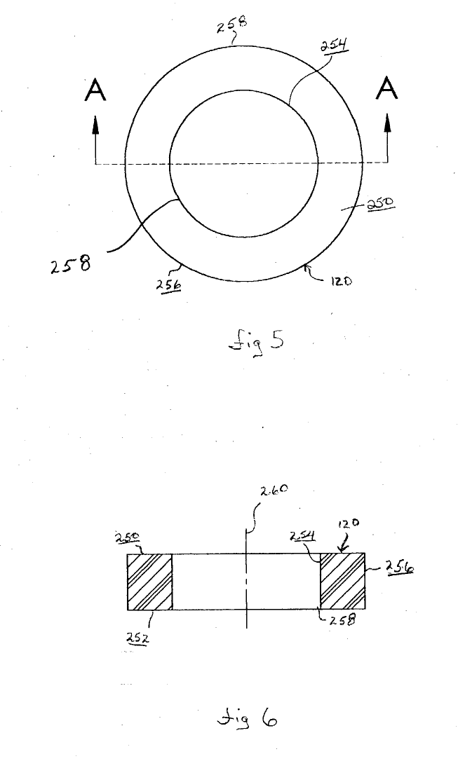

Now referring to FIGS. 1-4, the fork 110 is generally unitary in this embodiment, but may be considered to include a cylindrical element 150, extensions such as legs 152, 154, and 156, and a lower element such as a platform 158. The cylindrical element 150 displays an inner surface 160, an outer surface 162, a top surface 164, and a bottom surface 166. An optional groove 168 is defined in the cylindrical element 150 such that the groove 168 extends outwardly from the inner surface 160. An optional score (groove) 170 extends inwardly from the outer surface 162, e.g., to a depth of between about 0.030 and 0.035 inch. A depth of between 60% and 70% of the total thickness of the cylindrical element 150 has been found to be satisfactory for the score 170 in this embodiment and a depth of 0.050 (+/−0.005) inch has been found satisfactory with respect to the groove 168. By way of illustration and not limitation, this embodiment of the cylindrical element 150 has an outer diameter of 1.300 (+/−0.010) inches, an inner diameter of 1.100 (+/−0.005) inches, and a thickness of 0.100 (+/−0.010) inch.

In this embodiment, the legs 152, 154, and 156 depend (extend) from the cylindrical element 150. The legs 152, 154, and 156 display respective inner surfaces 172, 174 (not shown), and 176, outer surfaces 178, 180, and 182, and bottom surfaces 184, 186, and 188. Extensions such as lips 190, 192, and 194 extend inwardly from the respective legs 152, 154, and 156. The lips 190, 192, and 194, in turn, display respective contact surfaces 196, 198, and 200, inner surfaces 202, 204 (not shown), and 206 and lower (contact or locking) surfaces 208, 210 (not shown), and 212. With respect to leg 152 and without limitation (legs 154 and 156 being substantially identical in this embodiment), the distance between surfaces 208 and 166 is 0.275 (+/−0.005) inch, the distance between inner and outer surfaces 172 and 178 is about 0.070 (+/−0.005) inch. Concerning lip 190 and without limitation (lips 192 and 194 being substantially identical in this embodiment), the distance between surfaces 178 and 202 is about 0.145 (+/−0.005) inch, the distance between surfaces 208 and 184 is 0.075 (+/−0.001) inch, the distance from the intersection of surfaces 196 and 202 to the intersection of surfaces 202 and 208 is 0.025 (+/−0.005) inch, and the contact surface 196 is angled from the lower surface 184 by an acute angle, e.g, by about 45 (+/−1.5, 2.5, 5.0) degrees. The legs 152, 154, and 156 and lips 190, 192, and 194 are equidistantly spaced, occupy arcs of about 30 (+/−1.5, 2.5, 5.0) degrees, and are hence separated by arcs of 90 (+/−1.5, 2.5, 5.0) degrees. The legs 152, 154, and 156 may unitarily extend from the cylindrical element 150 such that the leg outer surfaces 178, 180, and 182 are continuous with the cylindrical element outer surface 162.

In this embodiment, the platform 158 extends inwardly from the cylindrical element 150 and displays respective upper and inner surfaces 220 and 222. The bottom surface of the platform 158 is coextensive with the bottom surface 166 of cylindrical element 150. The platform inner surface 222 coaxially defines a bore 224 about an axis 226. A recess 228 is defined by an inner surface 230 and lower surface 232. The recess 228 may have a depth of about 0.020 (+/−0.005) inch and a diameter of 0.820 (+/−0.005) inch. The distance between the surfaces 166 and 220 maybe about 0.010 (+/−0.005) inch.

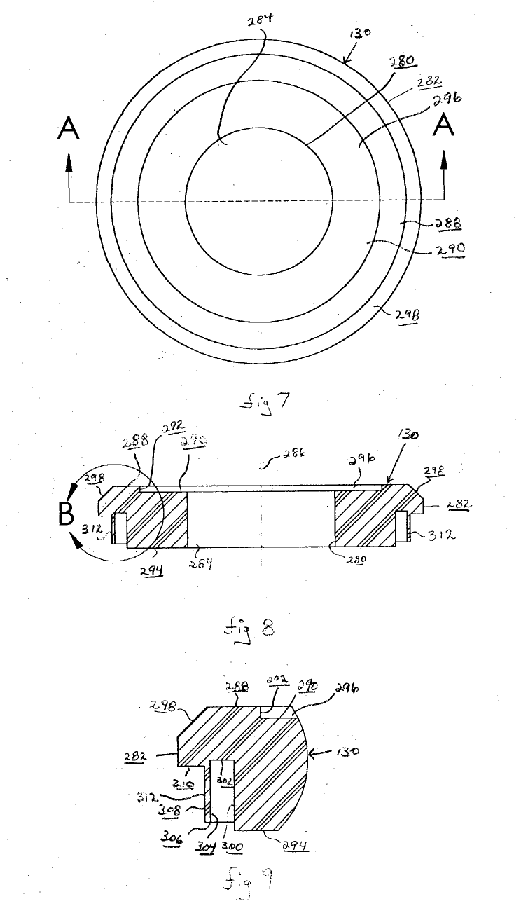

Referring now to FIGS. 1, 5, and 6, the exemplary compression ring 120 displays respective upper, lower, inner, and outer surfaces 250, 252, 254, and 256. The compression ring inner surface 254 coaxially defines a bore 258 about an axis 260. By way of illustration and not limitation, the diameter of the compression ring is 0.800 (+/−0.005) inch and the diameter of the bore 258 is about 0.500 (+/−0.005) inch. The distance between the upper and lower surfaces 250 and 252, hence the thickness, of the compression ring 120 is 0.190 (+/−0.010) inch in this embodiment, although the dimensions of the present compression ring may be determined by such factors as the dimensions of the device, the preset torque level, and the type of materials from which the present compression ring is made. The compression ring 120 is dimensioned to be accommodated in the platform recess 288.

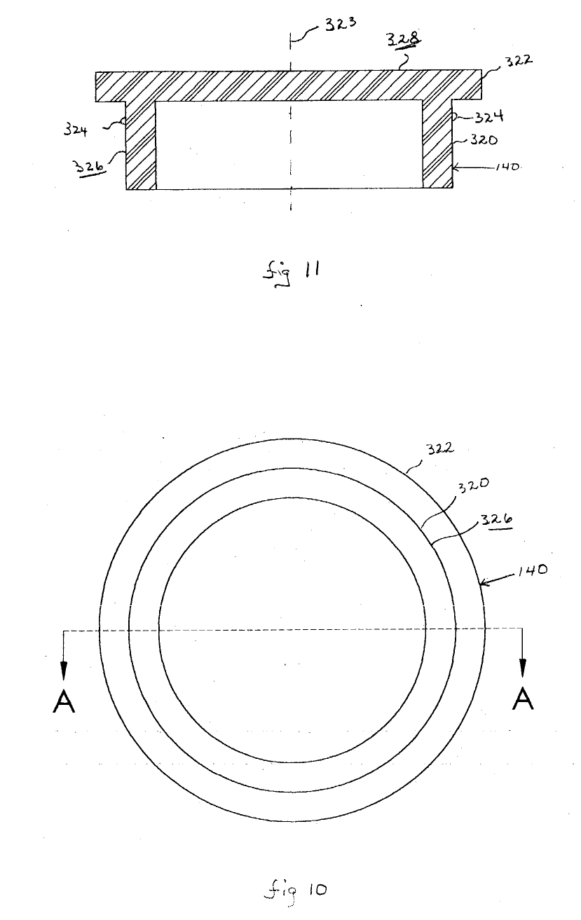

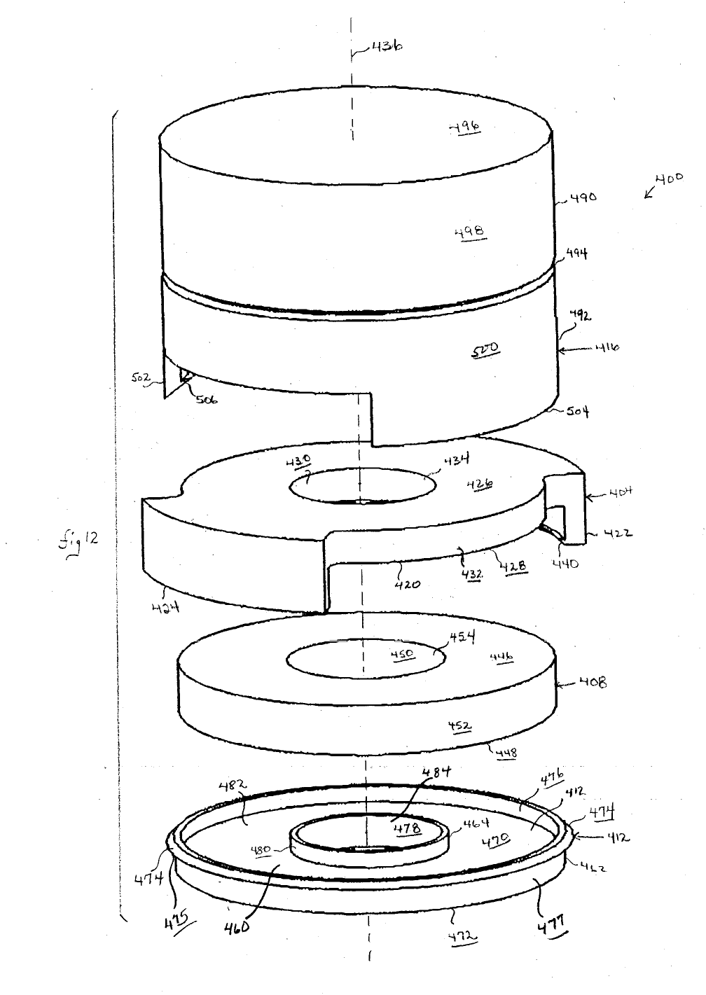

FIGS. 1, 7, 8, and 9 depict the exemplary base 130. The base 130 displays a first inner surface 280 and a first outer surface 282. The first inner surface 280 may be about 0.050 (+/−0.001) inch in height and may coaxially define a bore 284 about an axis 286. The base 130 displays respective first and second upper surfaces 288 and 290, a surface 292 extending generally perpendicularly (or otherwise transversely) between the upper surfaces 288 and 290, and a first lower surface 294. In one embodiment, the distance between surfaces 288 and 294, hence the thickness of this portion of the base 130, is 0.225 (+/−0.005) inch. The upper and transverse surfaces 290 and 292 define a recess 296. The recess 296 may have a diameter of about 0.820 (+/−0.005) inch and a depth of about 0.020 (+/−0.005) inch. The dimensions (e.g., diameter) of the recess 296 may be substantially identical to those of the platform recess 228 and may be dimensioned to accommodate the compression ring 120 therewithin. A contact surface 298 extends between the upper surface 288 and the outer surface 282. In this embodiment, the contact surface 298 is angled from the upper surface 288 by an acute angle, e.g., by about 45 (+/−1.5, 2.5, 5.0) degrees. The contact surfaces 196 and 298 may be angled to a greater or lesser extent depending on factors such as the materials from which the present fork and base are made and the preset torque level. A second outer surface 300 perpendicularly (or otherwise transversely) extends between the first lower surface 294 and a second lower surface 302. A second inner surface 304 extends perpendicularly (or otherwise transversely) between the second lower surface 302 and a third lower surface 306. A third outer surface 308 extends perpendicularly (or otherwise transversely) between the third lower surface 306 and a fourth lower surface 310. The fourth lower surface 310 perpendicularly (or otherwise transversely) intersects the first outer surface 282. The second inner surface 304, the third lower surface 306, and the third outer surface 308 define a contact element 312. As seen in FIG. 9, the second lower surface 302 is generally higher than (offset from) the fourth lower surface 310, e.g., by about 0.010 (+/−0.005) inch. The contact-element 312 is separated from the main portion of the base 132, e.g., by about 0.040 (+/−0.005) inch, is offset from the outer surface 282, e.g., by about 0.045 (+/−0.005) inch, and depends from the main portion of the base 130, e.g., by a length of about 0.095 (+/−0.005) inch, in this embodiment. The bottom surface 306 may be offset about 0.030 (+/−0.005) inch. As will be explained more fully below, the contact element 312 may have other dimensions depending on factors such as the desired pitch and volume of sound to be emitted and properties (e.g., resilience, weight) of the materials from which it is made.

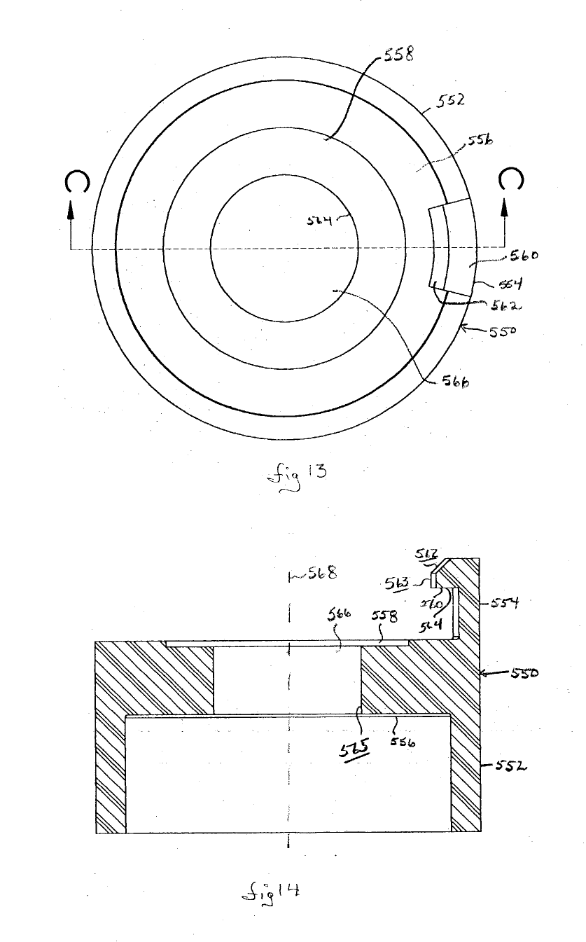

As shown in FIGS. 1, 10 and 11, the cap 140 unitarily includes a cylindrical element 320 and a top element 322 coaxially disposed about an axis 323. The cylindrical element 320 has a bead 324 extending from an exterior surface 326. The bead 324 is sized and dimensioned to be accommodated in the groove 168 of the fork cylindrical element. Moreover, the cylindrical element 320 is dimensioned to fit snugly into the fork cylindrical element 150. By way of illustration and not limitation, the top element 322 displays a top surface 328, is 0.100 (+/−0.010) inch in thickness, and 1.300 (+/−0.005) inches in diameter. The cylindrical element 320 has a height of 0.300 (+/−0.010) inch, an inner diameter of 0.900 (+/−0.010) inch, an outer diameter of 1.100 (+/−0.005) inch, and a thickness of 0.100 (+/−0.05) inch.

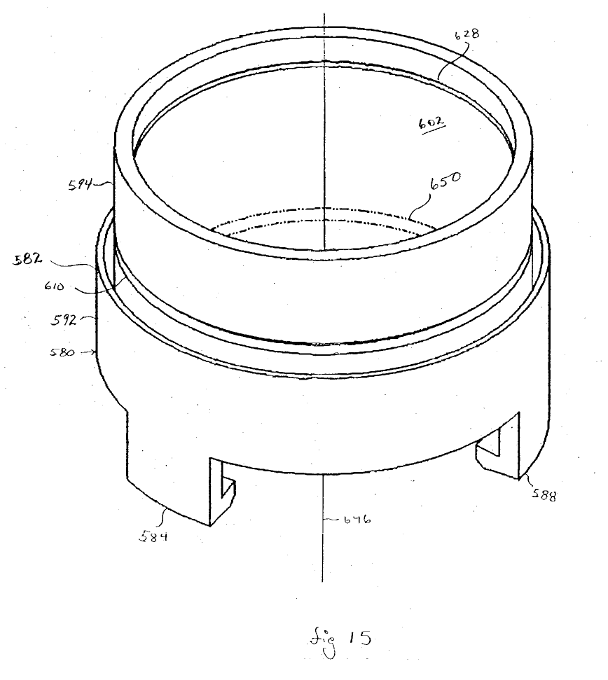

A second embodiment of the present torque lock/torque indicator is depicted in FIG. 12 at 400 and includes an upper (first) member such as a fork 404, a compression member such as a ring 408, a lower (second) member such as a base 412, and an optional tamper preventive device such as a cap 416.

The fork 404 has a generally central disk element 420 and a pair of oppositely disposed extensions such as legs 422 and 424, although more legs could be present in some embodiments. The disk element 420 displays an upper surface 426, a lower surface 428, an inner surface 430, and an outer surface 432. The inner surface 430 coaxially defines a bore 434 about an axis 436. Respective lips 440 and 442 (not shown) extend from the legs 422 and 424. Contact surfaces, such as described above, are present on the lips 440 and 442. A recess may be defined proximate the lower surface 428 and may be dimensioned to accommodate the ring 408, as more fully described above with respect to the ring 120.

One embodiment of the present compression ring is shown at 408. The compression ring 408 displays an upper surface 446, a lower surface 448, an inner surface 450, and an outer surface 452. The inner surface 450 defines a bore 454 coaxially about the axis 436. The dimensions of the ring 408 and materials from which the ring 408 is made are determined by considerations discussed and disclosed elsewhere herein.

The base 412 may include a disk element 460, an outer rim 462, and an inner rim 464. The disk element 460 displays respective upper and lower surfaces 470 and 472. The outer rim 462 terminates in an upper contact surface 474 and a lower contact (locking) surface 474. The contact surface 474 and the contact surface of the lips 440 and 442 may be configured similarly, or substantially identically, to the contact surfaces described with respect to the embodiment 100, above. The outer rim 462 displays an inner surface 476 and an outer surface 477. The inner rim 464 displays respective inner and outer surfaces 478 and 480. The inner surface 476, the upper surface 470, and the outer surface 480 define a recess 482. The recess 482 is dimensioned to accommodate the compression ring 408 therein. The rim inner surface 478 coaxially defines a bore 484 about the axis 436.

The cap 416 may be considered to have an upper portion 490 and a lower portion 492, the upper and lower portions separated at a score (groove) 494. In one embodiment, the score 494 is about 0.050 (+/−0.005) inch in depth. The upper portion 490 displays an upper surface 496 and an outer surface 498. The lower portion 492 displays an outer surface 500. A plurality of extensions, such as a pair of legs 502 and 504 depend from the lower portion 492. Respective lips 506 and 508 (not shown) extend inwardly from the legs 502 and 504 and include contact surfaces as discussed above with respect to the contact surfaces of the first fork embodiment 100.

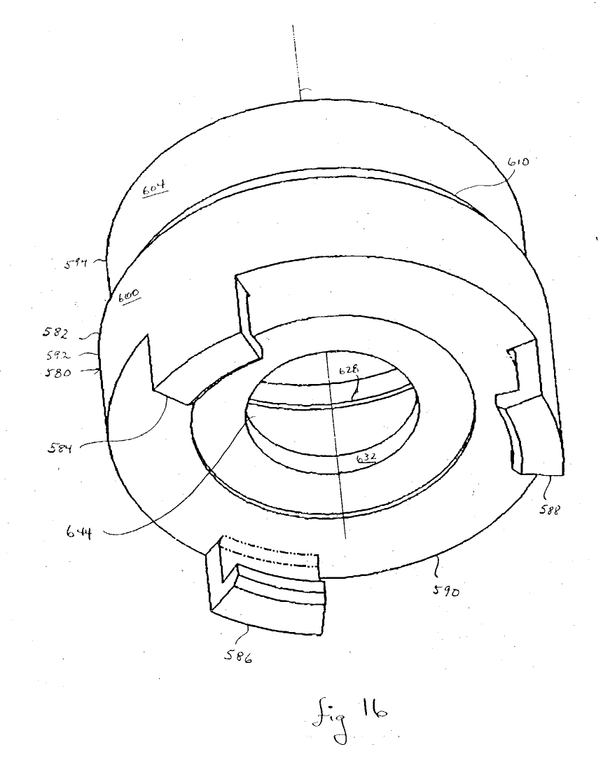

A third embodiment of the present upper (first) member is depicted in FIGS. 13 and 14 as fork 550. The fork 550 unitarily includes a cylindrical element 552, a single leg 554, and a platform 556. The cylindrical element 552 and the platform 556 may be similar, or substantially identical, to similar elements described with respect to other of the present embodiments, such as that designated as 100. A recess 558 may be formed in the platform 556 as described above with respect to embodiment 100, as well. The leg 554 includes a lip 560 with an angled contact surface 562, a vertical contact surface 563, and a lower contact(locking) surface 564. While the lip 560 and contact surfaces 562, 563, and 564 may be similar, or substantially identical, to similarly named elements of embodiment 100 as discussed above, the leg 554 may be between 50% and 75% longer than the legs of previous embodiments. As with previously discussed embodiments, an inner surface 565 of the platform 556 coaxially defines a bore 566 about an axis 568. The fork 550 may be used in lieu of other forks, e.g., fork 110, in some embodiments of this invention. Materials used in, and dimensions of, the fork 550 may be determined by considerations such as discussed with respect to the first embodiment 100 of this invention.

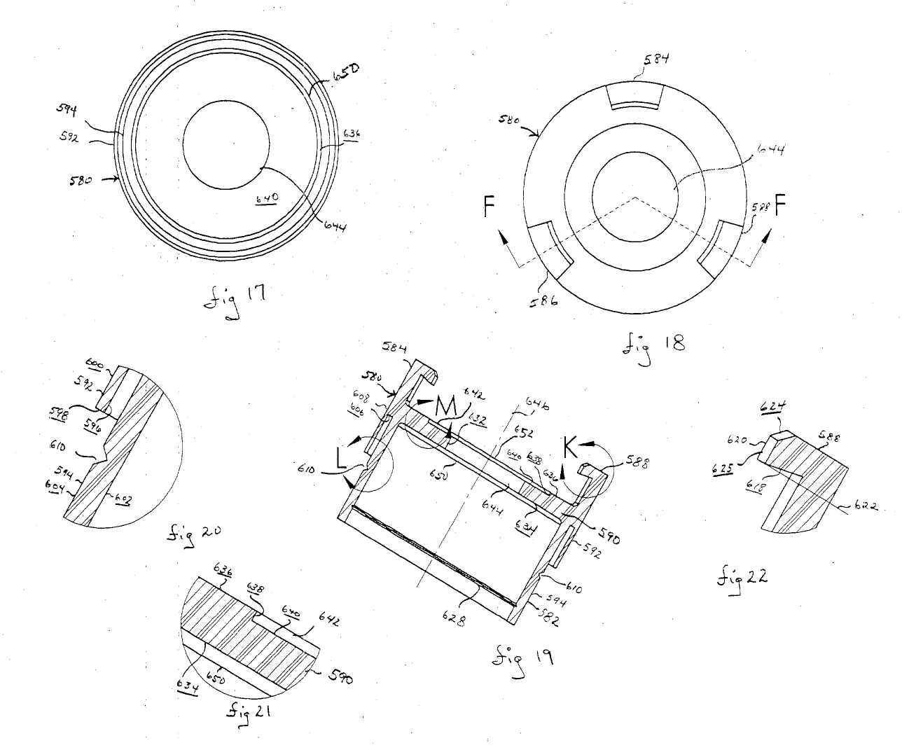

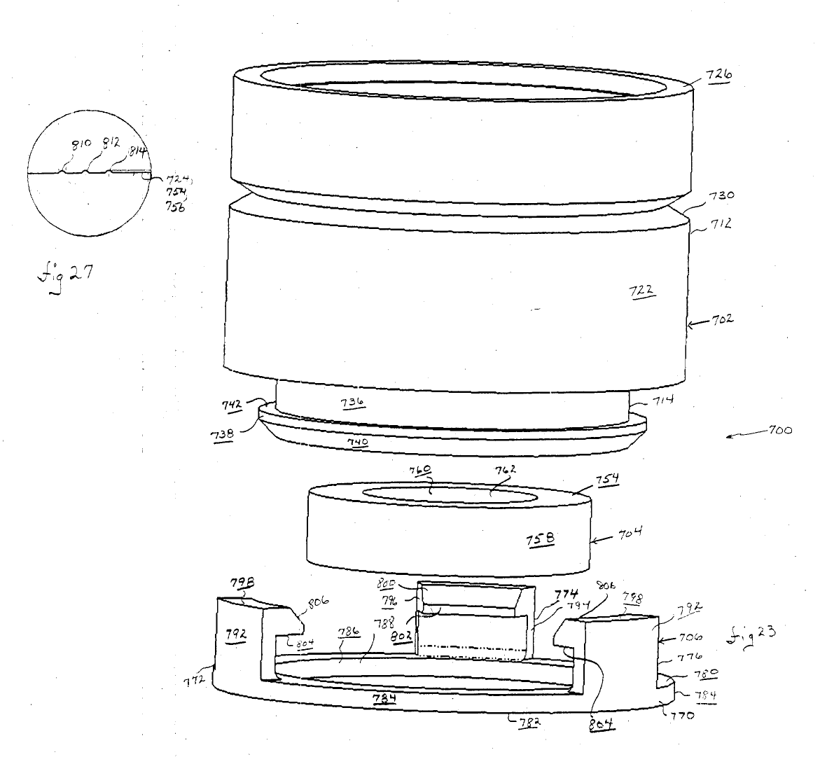

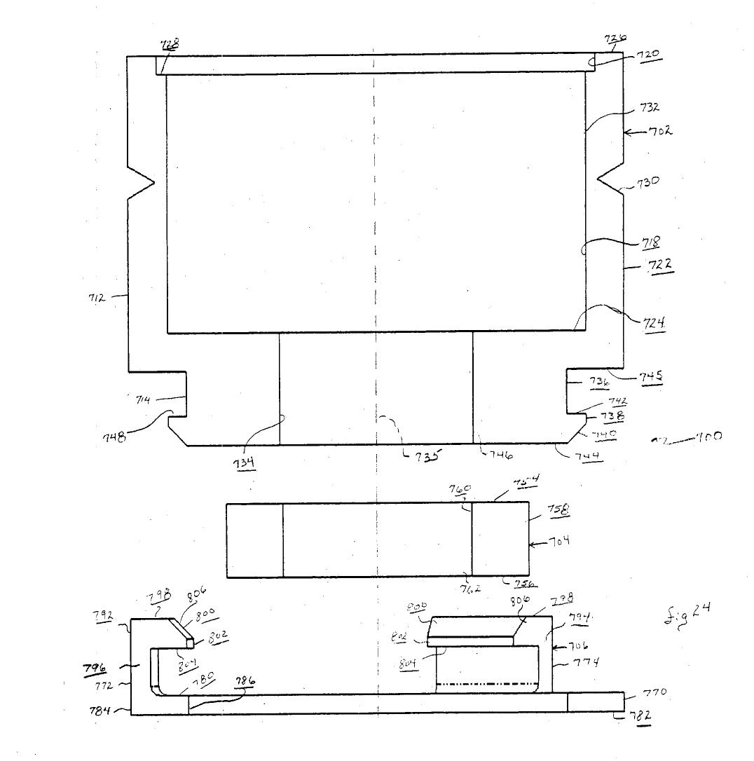

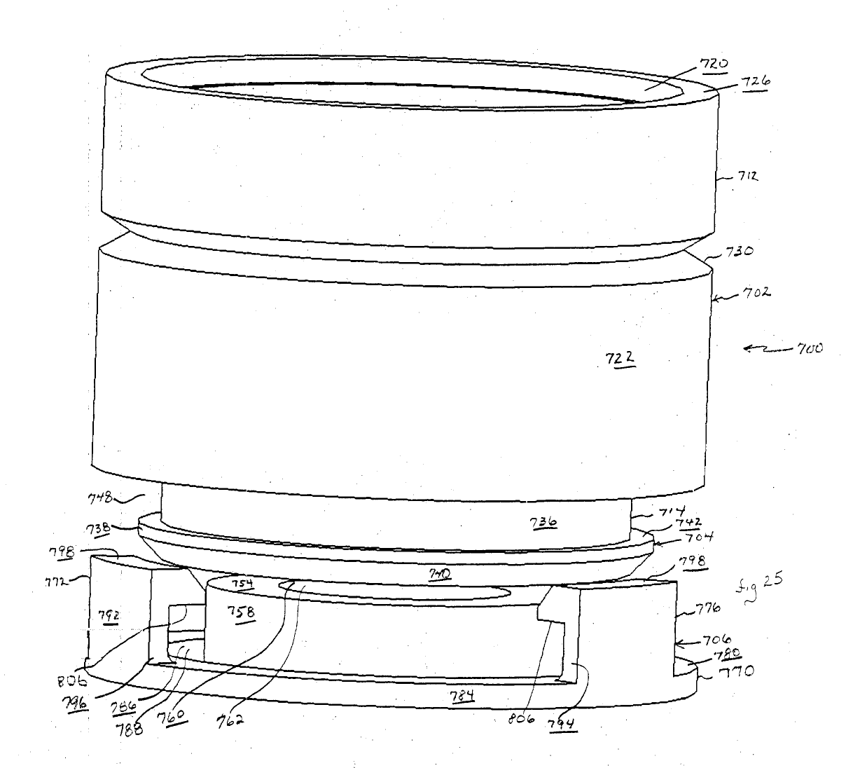

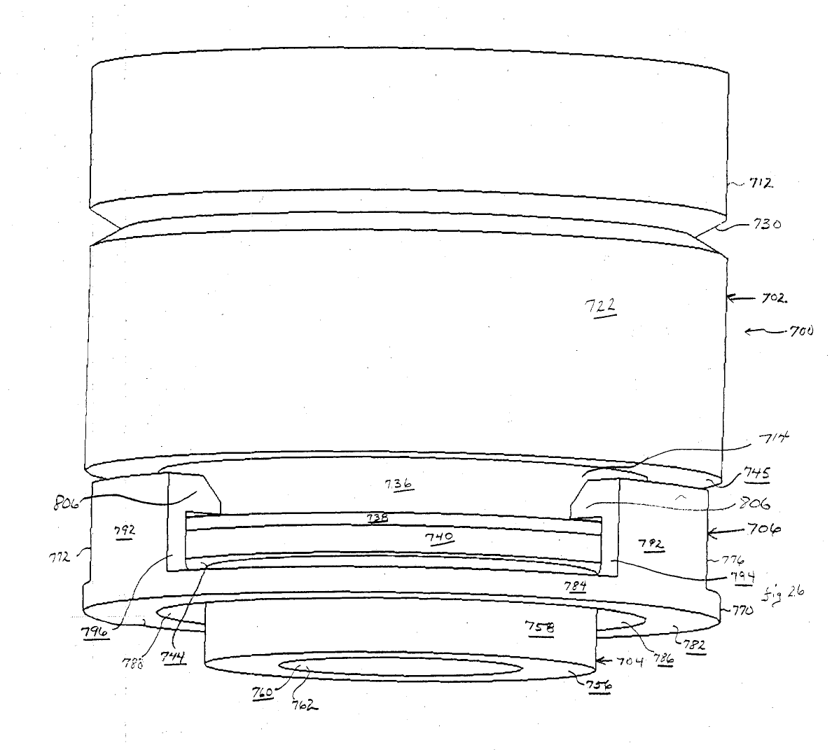

An exemplary fourth embodiment of the present upper (first) member is depicted in FIGS. 15-22 as an upper (first) element such as a fork 580. The fork 580 is substantially unitary in this embodiment, but may be considered to include a cylindrical element 582, a plurality of extensions, such as legs 584, 586, and 588, and a lower (second) element, such as a platform 590.

One difference between the cylindrical element 582 and other embodiments discussed above is the presence of an outer portion 592 and an inner portion 594. In this embodiment, the outer 592 and inner 594 portions are substantially concentric. The outer portion 592 displays respective inner, upper, and outer surfaces 596, 598, and 600. The inner portion 594 displays respective inner and outer surfaces 602 and 604. A second upper surface 606 is displayed on a base 608 of the fork 580 and spans between the outer portion 592 and the inner portion 594. The distance between upper surfaces 598 and 606, hence the length of the outer portion 592, may be about 0.725 (+/−0.005) inch. The distance between the inner and outer surfaces 596 and 600, hence the thickness of the outer portion 592, may be about 0.020 (+/−0.005) inch and the distance between the inner and outer surfaces 602 and 604, hence the thickness of the inner portion 594, may be about 0.050 (+/−0.005) inch. The inner portion 594 and outer portion 592 may be separated by a gap of 0.030 (+/−0.005) inch. A groove 610 is defined in inner portion 594 and may extend inwardly from the outer surface 604 thereof to a depth between about 0.030 and 0.035 inches or to a depth of between about 60% and 70% of the total thickness of the inner portion 594.

Another difference between this and other embodiments is the conformation of the legs 584, 586, and 588. Without limitation and referring to the leg 588 (legs 584 and 586 being substantially identical in this embodiment), an upper contact (locking) surface 618 of lip 620 thereof, is angled from a horizontal orientation 622 by an acute angle, e.g., about 12 (+/−0.5, 1.0, 1.5) degrees. Angled contact surface 624 and vertical contact surface 625 are configured similarly, or substantially identically, to similar contact surfaces displayed on legs of other embodiments and are discussed elsewhere.

A groove 628 is defined in the inner portion 594 and may extend from the inner surface 602 to a depth of 0.100 (+/−0.010) inch. The platform 590 displays an inner surface 632, an upper surface 634, a first lower surface 636, a second inner surface 638, and a second lower surface 640. The second inner surface 638 and the second lower surface 640 define a recess 642. The recess 642 may be substantially similar, or identical, to the other recesses of this invention in dimension and function. The first inner surface 632 coaxially defines a bore 644 about an axis 646. An angular or arcuate portion such as fillets 650 and 652 may be present where the platform surfaces join the cylindrical element inner surface. Moreover, similar angular or arcuate portions may be present at any place where surfaces would otherwise angularly join in the devices of this invention.

Functionally, the preceding embodiments of the present torque lock/torque indicator may be assembled for convenience into substantially two components. However, the present torque lock/torque indicator may also be represented in unitary (or otherwise integral) embodiments, as will be more fully described hereinbelow. The first component would include the fork 110, compression ring 120, and base 130 adheringly assembled. One procedure would include cementing (or otherwise adhering, e.g., via sonic welding) the fork 110 to the upper surface of the compression ring 120 and the base 130 to the lower surface of the compression ring 120. The fork 110, compression ring 120, and base 130 would be assembled such that the axes 226, 260, and 286 are aligned as indicated at 580 in FIG. 1. Similarly and referring to FIG. 12, the fork lower surface 428 would be adhered to the disk element upper surface 446 and the disk element lower surface 448 would be adhered to the surface 470 of the base 412.

In use and referring to FIGS. 1-11, a connector (such as an oil drain plug (not shown)) is inserted through bores 224, 258 and 284 such that the connector head contacts the platform upper surface 220 of the fork 110 and such that the fork contact surfaces 196, 198, and 200 contact the base contact surface 298. The connector may snugly fit within the bores 224, 258, and 284. The connector is then threaded, e.g., into the drain, and tightened to a desired, predetermined torque level. As the predetermined torque level is approached, the legs 152, 154, and 156 are displaced downwardly and from an unbiased position toward an outwardly biased position in which the fork contact surfaces 196, 198, and 200 slip past the base contact surface 298, slightly angling the leg ends (e.g., surfaces 184, 186, and 188) outwardly, thereby biasing the legs 152, 154, and 156 outwardly. Tightening the connector further compresses the compression ring 120 and displaces the leg inner surfaces 202, 204, and 206 past the base contact surface 298. Continuing to tighten the connector still further compresses the compression ring 120, to allow the legs to return to (or toward) their previous, generally vertical (unbiased) positions and interlocks the fork 110, compression ring 120, and base 130 together by abutting surfaces 208, 210, and 212 against the surface 310 of the base 130. The legs 152, 154, and 156 return to their previous, generally vertical, unbiased positions very quickly and with considerable force, thereby generating an audible sound and/or a tactilely discernible vibration in some embodiments of this invention. The sound and/or vibration are believed to be generated as surfaces 202, 204, and 206 forcefully strike the base surface 308, thereby vibrating the contact element 312. In one embodiment, the connector has been tightened to a predetermined torque level upon generation of the sound and/or vibration. However, in another embodiment, the connector is then further rotated, e.g., one-fourth of a turn, to arrive at the predetermined torque level.

In the embodiment represented in FIGS. 15-22, the angled lip upper surface 618 functions to eliminate, or minimize, friction-generating contact between the lip upper surface 618 and the lower surface 310 of the base 130. Otherwise, the force at which the legs return toward an unbiased position would be somewhat dissipated by the friction between the lip upper surface and the base lower surface. Therefore, the force with which the contact element would be impacted by the lip surface would be diminished as well and the resulting sound would be lower in magnitude.

Referring further to the embodiment represented by FIGS. 15-22, the outer portion 592 of the cylindrical element 582 further amplifies the sound emitted when the extension lips strike the base contact element. It is believed that the impact of the lips striking the base contact element causes both the cylindrical element outer portion and contact element to vibrate, thereby amplifying the sound generated.

In addition to the audible indicator, the outward, then inward, displacement of the legs is a visual indicator that the predetermined, desired torque level has been attained. Moreover, the vibration occurring when the sound is generated can also be felt by the person tightening the connector. Thus, the person tightening the connector is alerted by hearing the sound, feeling the vibration, and by seeing the outward, then inward leg displacement, when the desired torque level has been attained. Obviously, operating the torque lock 400 of FIG. 12 and the fork 550 would be substantially identical, or similar, and the same sensory indicators would indicate that the desired, predetermined torque level has been achieved. It is contemplated that the present base, when secured as described above, will also provide a fluid-tight seal. This sealing feature of the present base is especially advantageous when the present device is used to ensure that oil drain plugs are tightened at proper torque levels.

Once the desired torque level has been attained, one of caps 140 or 416 may be used to prevent the connector from being loosened or otherwise tampered with. Referring to FIG. 1, the cylindrical element 320 of the cap 140 is pressed into cylindrical element 150 of the fork 110 until the bead 324 is disposed in the grooves 168, thereby securing the cap 140 in place. Additionally, the cap 140 can be further secured within the fork 110 by using an adhesive, such as cement or a solvent such as acetone. Referring to FIG. 12, the contact surfaces of the cap 416 are pressed against the contact surfaces of the base 412, then further pressed, thereby flexing (biasing) the legs outwardly, then still further pressed until the legs straighten into an unbiased position as explained above. The caps are thusly locked into place and cannot be removed without being destroyed. The presence of intact caps locked and/or cemented into place indicates that the assembly has not been tampered with and the connector is in place at the desired torque.

When it is desired to remove the connector, the upper portion of the cap can be grasped, e.g., with pliers, and separated from the upper portion of the cap by breaking the cap along the score 494. Alternatively, a hammer can be used to break the cap, either method allowing access to the connector for removal.

Referring to FIGS. 23-27, a fifth embodiment of the present invention is depicted generally at 700 and includes an upper (first) member 702, a compression ring 704, a lower (second) member (base) 706, and an optional cap (not shown). In this embodiment, the upper member 702 unitarily defines respective first and second cylindrical elements 712 and 714 such that the second cylindrical element 714 extends (depends) from the first cylindrical element 712. However, the first cylindrical element 712 (and equivalent structures of other embodiments) may be missing in embodiments when a tamperproof seal is not desired. The first cylindrical element 712 displays respective first and second inner surfaces 718 and 720, an outer surface 722, a lower surface 724, and first and second upper surfaces 726 and 728. If the optional cap is used in this embodiment, a groove (not shown), such as the groove 168 of the cap 140, may be defined and positioned to extend outwardly from the first inner surface 718 so as to accommodate the bead 324 of the cap 140 when the cap 140 is positioned to prevent tampering. A notch 730 is defined in the first cylindrical element 712 so as to extend inwardly from the outer surface 722. A bore 732 is defined by the inner surface 718. The second cylindrical element 714 displays an inner surface 734, respective first, second (contact), and third (contact) outer surfaces 736, 738, and 740, an upper (contact or locking) surface 742, and respective first and second lower surfaces 744 and 745. A bore 746 is defined by the inner surface 734 and may be coaxial to the bore 732 of the first cylindrical element 712 (with respect to axis 735). The surfaces 738, 740, and 742 are functionally designated as contact surfaces, the significance of which being explained below. The outer surface 740 angles outwardly from the lower surface 744. In the embodiment shown, the outer surface 740 angles upwardly and away from the lower surface 744, extends between the lower surface 744 and the generally vertical contact surface 738, and is generally frustoconical, but may be arcuate (e.g., concave) as well.

By way of illustration and not limitation, the upper member 702 may have a height (as determined by the distance between first upper surface 726 and lower surface 744) of about 1.000 (+/−0.010) inch. The first cylindrical element 712 may have an outer diameter of 1.300 (+/−0.010) inch and an inner diameter of 1.100 (+/−0.010) inch (as measured using the second inner surface 720) or an inner diameter of 1.000 (+/−0.010) inch (as measured using the first inner surface 718). Stated otherwise, the bore 732 has a diameter of about 1.000 (+/−0.010) inch. The height of the first cylindrical element 712 (as measured between surfaces 726 and 745 is about 0.810 (+/−0.010) inch. The notch 730 is centered about 0.710 inch from the top surface 726 to a depth of between 60% and 70% of the thickness of the first cylindrical element 712. In this and other embodiments the notch may be positioned so as to easily provide access to the fastener (e.g., bolt head) when the sealed upper member has been broken along the notch. The second upper surface 728 is stepped from the first upper surface 726 by about 0.05 (+/−0.010) inch. The first outer surface 736, upper surface 742, and second lower surface 745 define a slot 748 about 0.115 (+/−0.010) inch in height (as measured between the surfaces 742 and 745. The bore 746 is about 0.510 (+/−0.010) inch in diameter and about 0.290 (+/−0.010) inch in height. The contact surfaces 740 extend outwardly from the lower surface 744 by an acute angle, e.g., about 45 (+/−5) degrees.

The compression ring 704 defines an upper surface 754, a lower surface 756, an outer surface 758, and an inner surface 760, the inner surface 760 defining a bore 762. In the embodiment depicted, the compression ring 704 has an axial thickness of about 0.185 (+/−0.010) inch (as measured between surfaces 754 and 756), has an outer diameter of 0.800 (+/−0.010) inch, and an inner diameter of 0.500 (+/−0.005) inch, the compression ring therefore having a radial thickness of about 0.150 (+/−0.010) inch (as measured between surfaces 758 and 760).

In the embodiment shown, the base 706 unitarily (or integrally) includes a ring element 770 and, in contrast to previously disclosed embodiments of this invention, a plurality of extensions, such as legs 772, 774, and 776. The ring element 770 displays an upper surface 780, a lower surface 782, an outer surface 784, and an inner surface 786, the inner surface 786 defining a bore 788. The legs 772, 774, and 776 are separated on the ring element 770 by an arc of about 90 degrees and extend to a width defined by an arc of about 30 degrees. Each leg 772, 774, and 776 is substantially identical in confirmation in the embodiment depicted and displays an outer surface 792, respective first and second side surfaces 794 and 796, respective first and second (contact) top surfaces 798 and 800, an inner (contact) surface 802, and a lower (contact or locking) surface 804. In the embodiment shown, the second top surface 800, inner surface 802 and portions of the first and second side surfaces 0.794 and 796, and first top surface 798 define an inwardly extending extension such as a lip 806. In the embodiment depicted, the ring element 770 has an outer diameter of about 1.300 (+/−0.010) inch and an inner diameter of about 1.000 (+/−0.010) inch, thereby having a radial thickness of about 0.150 (+/−0.010) inch. The axial thickness of the ring element 770 is about 0.050 (+/−0.010) inch (as measured between upper and lower surfaces 780 and 782). The lip 806 is about 0.121 (+/−0.010) inch above the ring element 770 (as determined between the surfaces 780 and 804). The lip 806 is about 0.075 (+/−0.010) inch and has an axial dimension (as measured between surfaces 798 and 804) of 0.075 (+/−0.010) inch and the upper surface 798 of the lip 806 is about 0.246 (+/−0.010) inch from the lower surface 782 of the ring element 770. The second top surface 800 angles downwardly from the first top surface 798 at an acute angle, e.g., about 45 (+/−5) degrees in this embodiment. The height of the inner surface 802 is about 0.025 (+/−0.001) inch (as measured between the lower surface 804 and the point at which the second top surface 800 intersects the inner surface 802). A person of ordinary skill in the art will readily comprehend that a greater number of extensions such as those designated 772-776 may be present, e.g., 4, 6, 8, 10, and that the number of extensions, lip upper surface angle, materials used, and material thickness can be selected to for a given embodiment of the present invention, which will operate at a desired torque or torque range, provide a sound with a desired pitch and volume, and emit a vibration of desired amplitude.

A security cap, such as the security cap 140, may be utilized to prevent tampering or loosening the tightened connector without destroying the integrity of the upper member 702 and/or cap, the occurrence of a tampering event thereby becoming apparent by the presence of a missing security cap or broken upper member 702.

In operation, a shaft of a connector (such as an oil plug) is extended through the bore 746 of the upper member 702, the bore 762 of the compression ring 704, and the bore 788 of the base 706, then threaded into the device, e.g., the oil pan. The connector is then tightened by being rotated until the lower surface of the bolt head contacts the lower surface 724 of the upper member 702. The connector is then further tightened, thereby forcing the lower surface 744 of the upper member 702 against the upper surface 754 of the compression ring 704. As the connector is yet further tightened, the compression ring 704 is compressed. Simultaneously with the compression ring 704 being compressed, the contact surface 740 of the upper member 702 slidingly contacts the contact (second top) surface of the legs 772, 774, and 776 and thereby biases (displaces) the legs 772, 774, and 776 outwardly as the upper member 702 is forced downward during tightening. As the connector is still further tightened, the second outer surface 738 of the upper member 702 slidingly contacts the inner surface 802 of each leg 772, 774, and 776. When the connector has been tightened to the predesignated level of torque by compressing the compression ring 704, the second outer surface 738 of the upper member 702 has been forced past the inner surface 802 of each leg 772, 774, and 776, thereby allowing the legs 772, 774, and 776 to return to their former generally vertical position. As the legs 772, 774, and 776 return the upper surface 800 and inner surface 802 of the legs strikingly contact the first outer surface 736 and the upper surface 742 of the upper member 702 creating an audible sound and generating a vibration which can be sensed by the hands of the person performing this procedure. In this position, the inner portions of the lips 806 of the legs 772, 774, and 776 are held within the slot 748 of the upper member 702, thereby fixing the base 706 to the upper member 702 by abutting the locking surfaces 742 and 804 and such that the base 706 can freely rotate while locked to the now stationary upper member 702 when the predetermined amount of torque has been applied to the bolt. Before the predetermined amount of torque has been applied, the legs 772, 774, and 776 of the base 706 are biased so as to frictionally engage the base 706 and thereby prevent the base 706 from being freely rotated. The free rotation of the base thus serves as a second visual indicator that the predetermined amount of torque has been applied to the bolt. A first visual indicator that the predetermined amount of torque has been applied is the return of the legs 772, 774, and 776 to a generally vertical position from being biased generally outwardly. A second visual indicator that the predetermined amount of torque has been applied is the ability to freely rotate the base 706 as discussed above. After the predetermined amount of torque has been applied to the bolt, the cap is then inserted into the upper member 702 and fixed in place, e.g., by using an adhesive or by seating the bead (e.g., bead 324 of the cap 140) into the groove (not shown) defined in the inner surface 718 of the upper member 702 in the same manner explained above with respect to the groove 168 of the cylindrical element 150. In one embodiment, the seated cap cannot be removed from the upper member 702 without breaking the integral bonded cap and upper member, e.g., at the notch 730. Stated otherwise, the properly torqued bolt cannot then be accessed without breaking the cap or upper member, the presence of a broken cap or upper member or of an accessible bolt being an indicator that the bolt has been tampered.

An alternate surface configuration for the surfaces of the present upper member contacting the connector head, e.g., lower surfaces 724 and 744 of the upper member 702, and for the surfaces of the lower member contacting, e.g., the compression ring surface and the oil pan surface, such as the upper and lower surfaces 754 and 756 of the compression ring 704 is shown in FIG. 27, wherein one or more raised portions, such as generally concentric ribs 810, 812, and 814, are formed. By way of illustration and not limitation, the ribs 810, 812, and 814 may be formed so as to have a height of about 0.005 (+/−0.001) inch and a width of about 0.015 (+/−0.001) inch. Where three ribs 810, 812, and 814 are formed on the surfaces of the upper member 704 and compression ring 704 and where the dimensions of these elements are substantially as described herein, the ribs 810, 812, and 814 may be disposed at respective radii of about 0.337, 0.387, and 0.437 (+/−0.050) inches. The presence of the ribs 810, 812, and 814 on the surfaces 724, 744, 754, and 757 may further ensure a fluid-impermeable seal when a connector has been tightened to a predetermined torque.

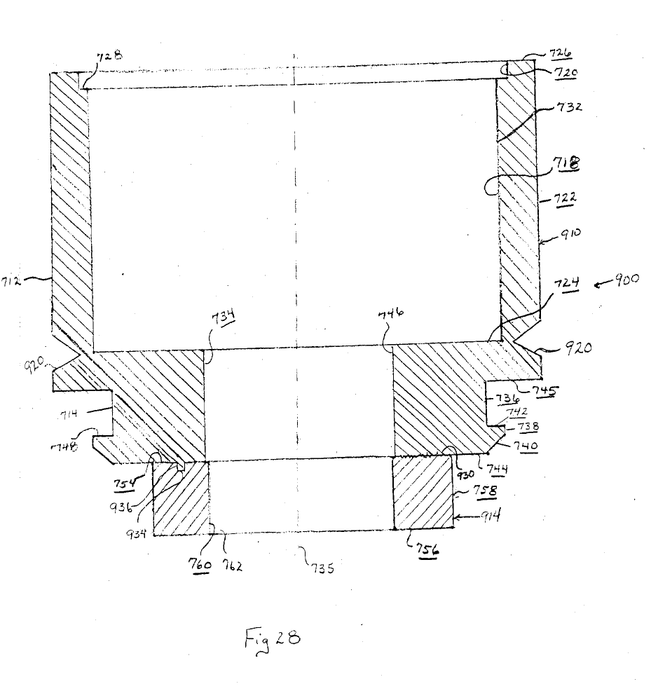

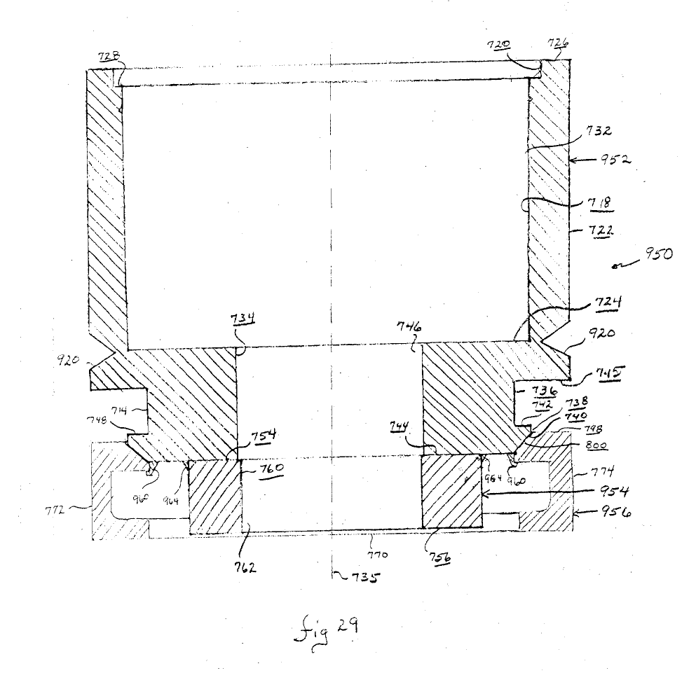

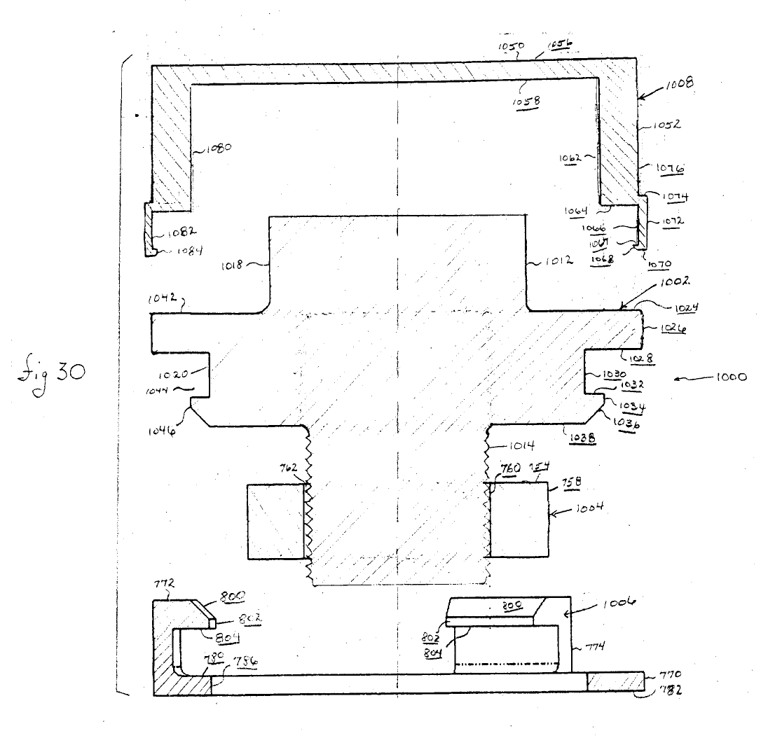

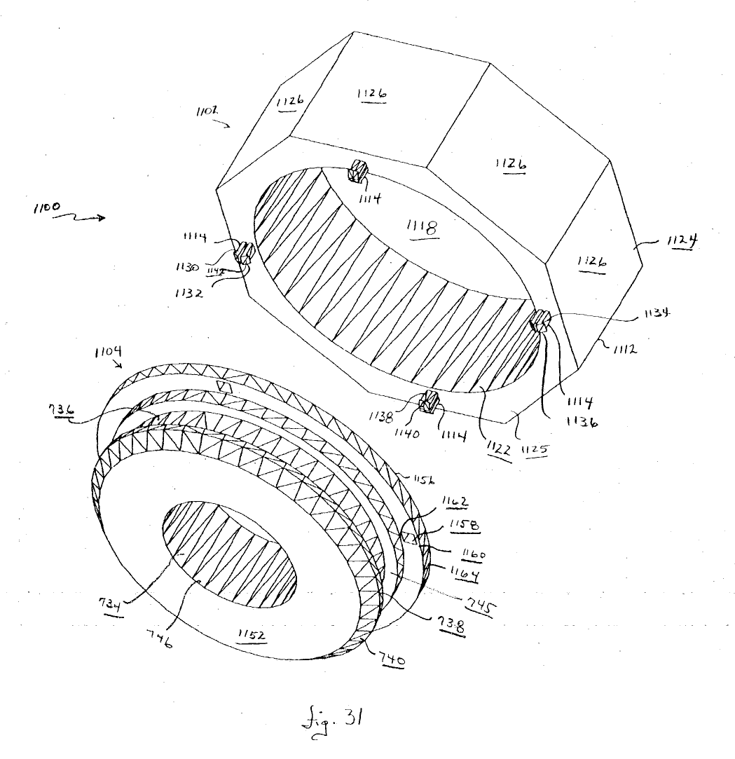

A sixth embodiment of the present torque lock/torque indicator is depicted in FIG. 28 at 900, which shows an upper (first) member 910 and a compression ring 914. A lower (second) member (not shown) suitably compatible with the upper member 910 and compression ring 914 will obviously be present and a person of ordinary skill in the art will readily comprehend how to suitably adapt other lower member embodiments for this purpose. Structures of the upper member 910 and the compression ring 914 are labeled identically to substantially similar structures present in the embodiment depicted in FIGS. 23-27. One difference is the location of the notch 920. The notch 920 may be dimensioned substantially similarly to the notch 730 depicted in FIGS. 23-27. However, the notch 920 is positioned so as to be proximate the location where the first and second cylindrical elements 712 and 714 adjoin. Locating the notch 920 in the position depicted in FIG. 28 provides for access to a fastener for virtually any tool to be used, e.g., socket, box-end wrench, open-end wrench, and enables faster and more complete access to the fastener in some embodiments. Another difference present in the embodiment depicted in FIG. 28 is that the upper member 910 and the compression ring 914 are bonded together at 930. The bond 930 may be effected by a “two-shot” molding process (Phillips Plastics Corp., Hudson, Wis. 54016, Phillips, Wis. 54555). The bond 930 may also be effected by using adhesives known to the art, or by such techniques as sonic welding. FIG. 28 also depicts another method of adhering the compression ring 914 to the upper member 910. A generally arcuate or circular notch 934 is defined so as to extend inwardly from the upper surface 754 of the compression ring 914 and a generally arcuate or circular lip 936 extends from the lower surface 744 of the upper member 910. The lip 936 is dimensioned and positioned so as to be snugly accommodated in the notch 934 and thereby adhere the compression ring 914 to the upper member 910, with or without the presence of additional adhesives or other means of adhering synthetic resins known to the art. Obviously, these methods of adhering compression rings to upper members of this invention can be used to adhere the present compression ring to any suitable embodiment of the present base as well. In some cases, adhering upper members, compression rings, and/or lower members is desirable so that assembly of these components prior to use is not necessary. Preassembly is often desirable to eliminate assembly error by persons changing oil and to save time when performing this operation.

In FIG. 29 a preassembled embodiment of the present torque lock/torque indicator is shown at 950 and includes an upper (first) member 952, a compression ring 954, and a lower (second) member 956. This embodiment may be substantially similar to previously discussed embodiments, e.g., those in FIGS. 23-27, except for the presence of the notch 920 (discussed previously in FIG. 28). To this end, elements substantially similar to those discussed and described in FIGS. 23-28 are numbered identically. Preassembly is accomplished by means of one or more tabs 960 and one or more tabs 964. The tab 960 connects the upper member 952 to the lower member 956 and the tab 964 connects the upper member 952 to the crush ring 954. The connected upper member 952, crush ring 954, and lower member 956 are ready for immediate use without assembly. This preassembled embodiment saves time and prevents mistakes, which might otherwise occur if assembly was necessary before use. In one embodiment, the tabs are molded onto the assembled components. However, a person of ordinary skill in the art would readily comprehend that the tabs could be affixed by adhesives, sonic welding, or the like. A person of ordinary skill in the art would further comprehend that the present upper member, crush ring, and lower member could be preassembled using adhesives, sonic welding, or by modifying a snap ring-like structure, in lieu of the tabs 960 and 964. It may be desirable in some embodiments that the tabs, or other equivalent embodiments of preassembling the present torque lock/torque indicator, would shear at a considerably lower force than the torque level desired for fastener installation, e.g., about five foot-pounds.

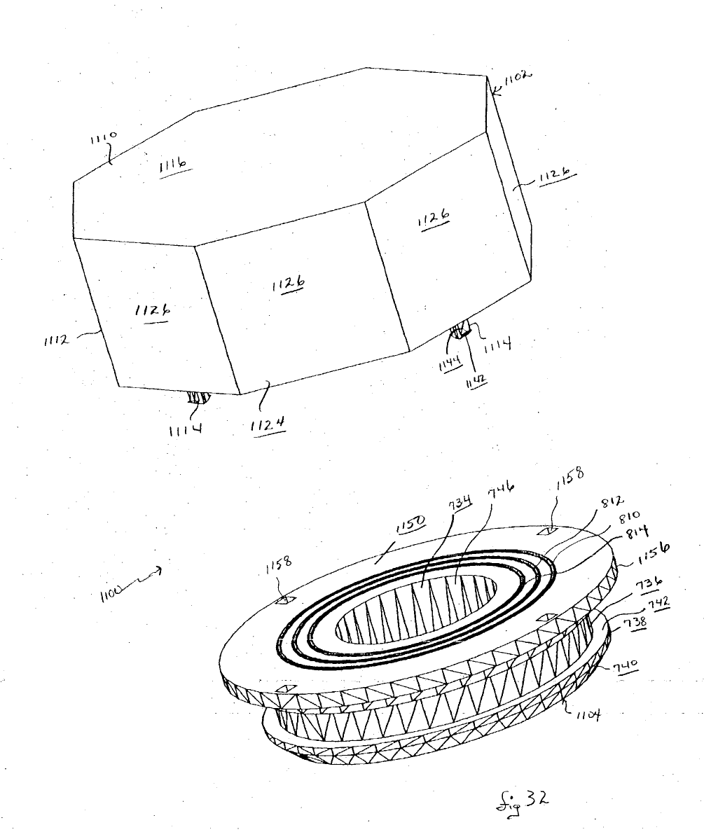

An eighth embodiment of the present torque lock/torque indicator is depicted in FIG. 30 at 1000 and includes a fastener 1002, a crush ring 1004, a lower (second) member 1006, and an optional cap 1008. The fastener 1002 advantageously includes a head 1012 and a threaded shaft 1014. The head 1012 is configured to function as an upper (first) member of the present invention, as more fully explained below. The head 1012, in turn, has an upper portion 1018 and a lower portion 1020. The upper portion 1018 may be configured to fit a wrench or socket. The lower portion 1020 displays a first upper (contact) surface 1024, a first outer (contact) surface 1026, a first lower (contact/locking) surface 1028, a second outer surface 1030, a second upper (contact/locking) surface 1032, a third outer (contact) surface 1034, a fourth angled (contact) surface 1036, and a second lower surface 1038. A first ledge 1042 is defined by the surfaces 1024, 1026, and 1028; an inset (groove) 1044 is defined by surfaces 1028, 1030, and 1032; a second ledge 1046 is defined by surfaces 1032, 1034, 1036, and 1038; and an inwardly extending rim 1084 is defined by the upper surface 1067 and angled surface 1067. The crush ring 1004 and the lower member 1006 may be substantially identical to the embodiments discussed and disclosed with respect to FIGS. 23-27, elements thereof being numbered identically. The cap 1008 is unitary in this embodiment, but may be considered to include respective upper and cylindrical portions 1050 and 1052. The upper portion 1050 displays respective upper and lower surfaces 1056 and 1058. The cylindrical portion 1052, in turn, displays a first inner surface 1062, a first lower (contact) surface 1064, a second inner surface 1066, an upper (contact/locking) surface 1067, an angled (contact) surface 1068, a second lower surface 1070, a first outer surface 1072, an upper surface 1074, and a second outer surface 1076. The first inner surface 1062, first lower surface 1064, and a second outer surface 1076 bound a main portion 1080 of the cylindrical portion 1052 and the other surfaces bound a contact portion 1082.

The fastener 1002, crush ring 1004, and lower member 1006 may be advantageously preassembled, the crush ring 1004 and lower member 1006 preassembled by structure equivalent or substantially identical to that disclosed and discussed with respect to FIGS. 28-29. The fastener 1002 may be preassembled to the crush ring 1004 by being dimensioned such that the shaft 1014 fits snugly within the bore 762 of the crush ring 1004, by being adhered thereto by an adhesive, or the like.

In use, the fastener 1002 is threaded, e.g., into a drain hole in an oil reservoir so that the surface 1036 of the second ledge 1046 contact the surfaces 800 of the legs 772-776 of the lower member 1006. The fastener 1000 is then further rotated, thereby slidingly displacing the second ledge 1046 past the legs 772-776. As the second ledge 1046 is displaced past the legs 772-776, the legs 772-776 are urged into an outwardly biased position. As the fastener 1002 is further rotated to the preselected amount of torque, the third outer surface 1034 of the second ledge 1046 is displaced past the inner surfaces 802 of the legs 772-776 and the legs 772-776 return to a vertical unbiased position. In the vertical unbiased position, the lower member 1006 is locked to the fastener 1002 via the abutting the locking surfaces 804 and 1032. As in a previous embodiment, the lower member 1006 may be freely rotated when locked to the fastener 1002. To prevent or detect access to the fastener, the cap 1008 is affixed to the fastener head 1012 by forcing the angled surface 1068 of the contact portion 1082 against the junction of the first upper surface 1024 and first outer surface 1026 of the fastener first ledge 1042 and flexes the contact portion 1082 outwardly. Force is further applied until the rim 1084 is displaced past the first outer surface 1026 of the ledge 1042 and the contact portion 1082 is allowed to return to a generally unbiased position. At this point, the cap 1008 becomes locked in place. The cap 1008 is locked in place when the first lower surface 1064 abuts the first upper surface 1024, the first outer surface 1026 abuts the second inner surface 1066, and the first lower surface 1028 abuts the upper surface 1067. In this embodiment the return of the legs 772-776 to a vertical unbiased position and being able to rotate the lower member 1006 are visual indicators that the correct amount of torque has been applied to the fastener 1002. Other indicators are the vibration felt by the operator when the legs 772-776 impact the second outer contact surface 1030 and the sound generated by the vibration.

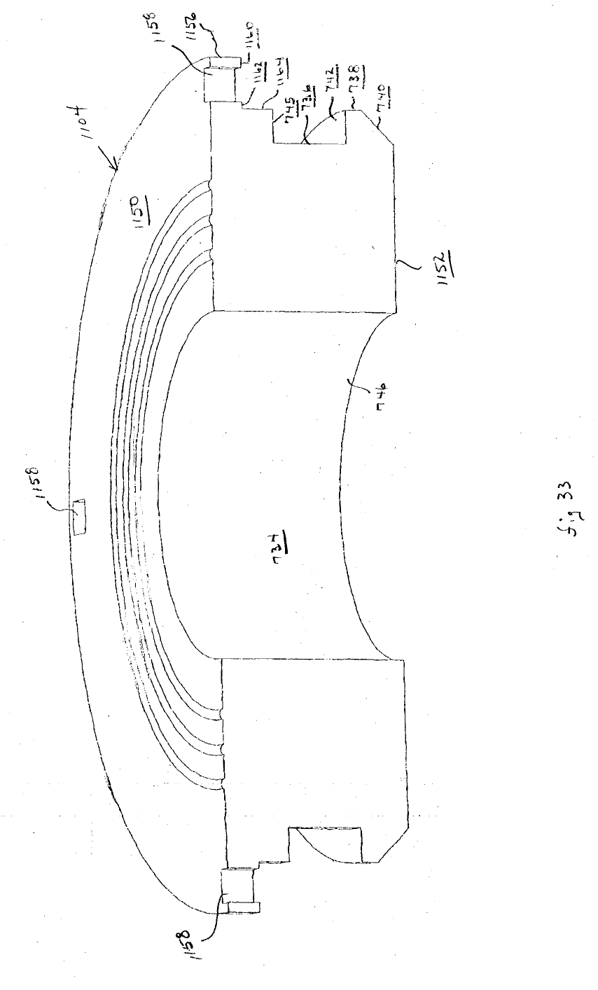

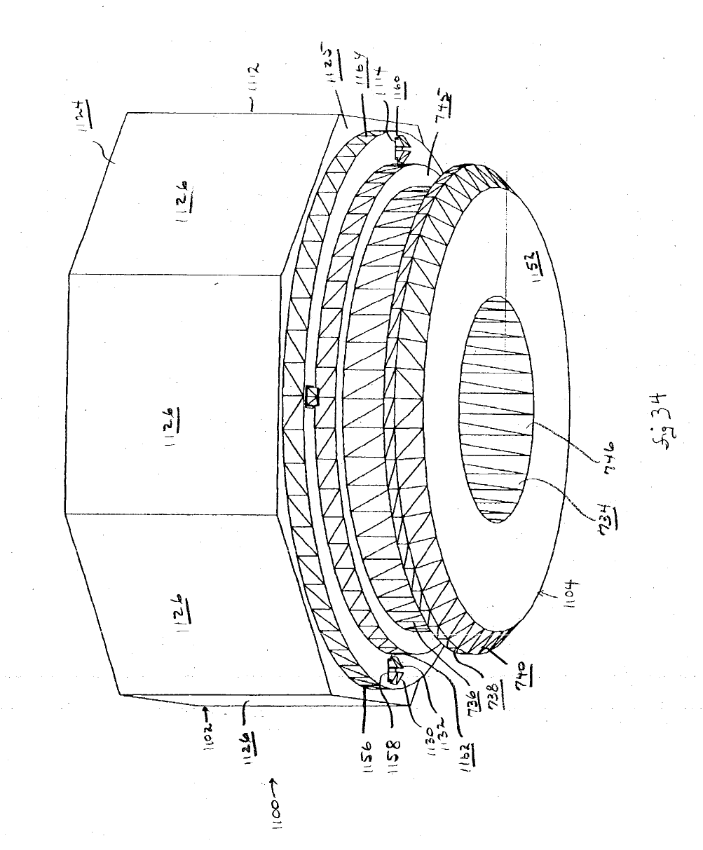

A ninth embodiment of the present torque lock/torque indicator is shown in FIGS. 31-34 at 1100 and includes a cap 1102 and a first member such as upper member 1104. It is understood that a compression ring and a lower member would be used with the cap a 1102 and the upper member 1104. Suitable embodiments of a compression ring and lower member are depicted in the FIGS. 23-27 and 29. It is further understood, however, that any of the present embodiments having the necessary structure could readily be adapted for use with the torque lock/torque indicator 1100. It is yet further understood that the cap 1102 and the upper member 1104 may be similar, or substantially identical, to the first and second cylindrical elements 712 and 714 depicted in FIGS. 23-27, except as described herein.

The cap 1102 includes a top 1110, a cap body 1112, and a plurality of (e.g., 4) tabs 1114. The cap top 1110 displays an upper surface 1116 and a lower surface 1118 and the cap body displays a generally cylindrical inner surface 1122, an outer surface 1124, and a bottom surface 1125. The outer surface 1124 may be subdivided by a plurality of faces 1126. In the embodiment shown, the faces 1126 form a hexagonal exterior so that the cap 1102 may be easily removed by a wrench when access to the sealed connector (e.g., oil plug) is desired. The tabs 1114 are depicted as including a two tab elements, such as exterior and interior tab elements 1130 and 1132. However, it should be appreciated that other embodiments of the tabs 1114 are within the spirit and scope of the present invention. For example, only one of the tab elements 1130 or 1132 may be present. The exterior tab elements 1130 may unitarilly, or otherwise integrally, include a stem member 1134 and a lip 1136 and the interior tab elements 1132 may likewise include a stem member 1138 and a lip 1140. Each lip 1136 and 1140 may display a lower sloped surface 1142 and an upper surface 1144. In the embodiment depicted, the upper surface 1144 is generally orthogonal to the stem members 1134 and 1138.

The upper member 1104 displays an upper surface 1150 and a lower surface 1152. Optional concentric ribs 810, 812, and 814 may be defined on the upper surface 1150. The concentric ribs 810, 812, and 814 may be similar or substantially identical to those embodiments discussed with respect to FIG. 27 and may be useful to prevent leakage during use. In contrast to the embodiments discussed with respect to FIGS. 23-27 and 29, a disk member 1156 may be present. A plurality of openings 1158 may be defined in of the disk member 1156. The openings 1158 are dimensioned and located so as to accommodate the tabs 1114. Lower surfaces 1160 and 1162 are defined by the disk member 1156 and are respectively outboard and inboard to the openings 1158. The disk member 1156 also defines an outer surface 1164 which adjoins the lower surface 1162. The lower surfaces 1160 and 1162 serve as locking surfaces when the tabs 1114 are inserted into the openings 1158. When thusly inserted, the sloped surface 1142 of each tab element 1130 and 1132 biases the tab element as the sloped surface 1142 is pressed against the upper surface 1150 and until the sloped surface 1142 is displaced sufficiently to allow the lips 1136 and 1140 to be pressed through the opening 1158. Once the tab 1114 has been extended through the opening 1158 to the extent that the lips 1136 and 1140 are free of the opening 1158, the stem members 1134 and 1138 return to their original orientation. The cap 1102 is thusly locked into place when the upper surfaces of 1144 abut the lower surfaces 1160 and 1162 of the disk member 1156. The other surfaces of the upper member 1104 are similar, or substantially identical, to the services described in the specification with respect to FIGS. 23-27 and 29 and are labeled as such.

Functionally, a connector, such as an oil plug, is extended through the bore 746 of the upper member 1104. The oil plug may then be extended through a bore of a compression ring, such as bore 762 of the compression ring 704 and through a bore of a ring element, such as bore 788 of the ring element 770. The oil plug is then tightened until indicators, as described above, show that the oil plug has been tightened to the desired amount of torque. At this point, the cap 1102 is affixed to the upper member 1104 by pressing the tabs 1114 into the openings 1158 (as described above). When access to the oil plug is desired, the cap 1104 may be removed by being twisted with a wrench fitted into the exceptional confirmation.

The compression ring of the present invention may be made from synthetic resins such as polyurethane, neoprene, acetals, or nylon (such as nylon 6/6 discussed below). Properties of a suitable polyurethane include a tensile break of 7500 psi, a 100% modulus of 5500 psi, an elongation of 225%, a compression set as determined by Method A (at 70 degrees Celsius) of 15%, a Shore Durometer of 75D, tear properties (pli, Die C) of 850, a Tabor abrasion resistance (H18 at 1000 gm load, mg loss/1000 cycles) of 450, a specific gravity of 1.18, and an ether base. One suitable polyurethane is marketed by Minnesota Plastics, Eden Prairie, Minn. as MP175TM. An acceptable acetal is marketed by Dupont as Delrin®. Obviously, other materials would be suitable for a given embodiment of the present compression ring as well. Usually an acceptable material for the present compression ring will seal well, be resistant to decomposition from liquids (e.g., petroleum-derived compounds), provide a consistent degree of resistance to compression, and rebound to its original shape well when compression is discontinued. Therefore, a person of ordinary skill in the art would choose a suitable material for the present compression ring to accommodate these and other factors discussed herein.

The other components can be constructed from materials such as synthetic resins as well. Two suitable synthetic resins suitable for this purpose are known as glass-fiber-reinforced nylon 6/6 and nylon 6/6. The glass-fiber-reinforced nylon 6/6 may be a 30% glass-fiber-reinforced nylon 6/6 with a density of 0.0488 lb/cu. in., a specific gravity of 1.35, a water absorption (24 hours at 73 degrees Fahrenheit) of 0.7%, a tensile strength (at 73 degrees Fahrenheit) of 27,000 psi, an elongation (at 73 degrees Fahrenheit) of 3%, a flexural strength (at 73 degrees Fahrenheit) of 39,100 psi, a flexural modulus (at 73 degrees Fahrenheit) of 12×105 psi, a Rockwell hardness of M101, an Izod impact strength (notched at 73 degrees Fahrenheit) of 2.1 ft-lb/in, a thermal deflection temperature at 66 psi of 490 degrees Fahrenheit, a thermal deflection temperature at 264 psi of 482 degrees Fahrenheit, a maximum temperature (long term) of 230 degrees Fahrenheit, a maximum temperature (short term) of 465 degrees Fahrenheit, a coefficient of linear thermal expansion (−20 degrees-200 degrees Fahrenheit) of 1.2×10-5 in/in/degree Fahrenheit, a dielectric strength of 530 V/mil, a dielectric constant (60 Hz, 73 degrees Fahrenheit, 50% RH) of 3.5, and an electrical volume resistivity (73 degrees Fahrenheit) of 1015 ohm cm. One suitable glass-fiber-reinforced nylon 6/6 is marketed by Minnesota Plastics, Eden Prairie, Minn. as ENSILON™ 6/6 GF30.

The nylon 6/6 may have a density of 0.0412 lb/cu. in., a specific gravity of 1.14, a water absorption (24 hours at 73 degrees Fahrenheit) of 8.5%, a tensile strength (at 73 degrees Fahrenheit) of 12,400 psi, an elongation (at 73 degrees Fahrenheit) of 90%, a flexural strength (at 73 degrees Fahrenheit) of 17,000 psi, a flexural modulus (at 73 degrees Fahrenheit) of 4.1×105 psi, a Rockwell hardness of R120-M79, an Izod impact strength (notched at 73 degrees Fahrenheit) of 1.2 ft-Lb/in, a thermal deflection temperature at 66 psi of 455 degrees Fahrenheit, a thermal deflection temperature at 264 psi of 194 degrees Fahrenheit, a maximum temperature (long term) of 2170 degrees Fahrenheit, a maximum temperature (short term) of 355 degrees Fahrenheit, a coefficient of linear thermal expansion (−20 degrees-200 degrees Fahrenheit) of 4.5×10-5 in/in/degree Fahrenheit, a coefficient of linear thermal expansion (200 degrees-460 degrees Fahrenheit) of 5.0×10-5 in/in/degree Fahrenheit, a dielectric strength of 600 V/mil, a dielectric constant (60 Hz, 73 degrees Fahrenheit, 50% RH) of 4.0, and an electrical volume resistivity (73 degrees Fahrenheit) of 1015 ohm cm. One suitable nylon 6/6 is marketed by Minnesota Plastics, Eden Prairie, Minn. as ENSILON™ 6/6.

Persons of ordinary skill in the art will also readily comprehend that such factors as thicknesses, lengths, and materials can be routinely altered to provide desired sound pitches and amplitudes and to accommodate any desired predetermined torque level. While utility with oil plugs is described, the present torque lock/indicator is obviously suitable for several uses where a fluid-tight seal is achieved by using a fastener such as a threaded bolt. While cross-sectional geometries depicted have been predominantly circular, persons of ordinary skill in the art will readily recognize that other cross-sectional geometries may be suitable in other embodiments of this invention.

When used as described herein, the present torque lock/indicator allows connectors to be tightened to a desired, predetermined torque level and secured against further tightening or tampering. The present torque lock/indicator thus protects the threads in components such as oil pans from being overstressed, stretched and stripped when connectors are being tightened therein. Moreover, the present torque lock/indicator provides a seal against fluid egress. The presence of the secured caps further ensures that the seal is in place, thus further preventing fluid egress or loss from tampering. Another advantage of the present torque lock/indicator is that threads of components are examined for integrity as connectors are tightened therein to desired, preset torque levels.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A torque-indicating device for use with a threaded fastener being threaded into a treaded opening, comprising:
a first member axially accommodating the fastener and comprising a first member locking surface and a first member contact surface, the first member locking surface disposed at an acute angle with respect to the first member contact surface;
a second member axially accommodating the fastener and comprising a plurality of second member locking surfaces and a plurality of second member contact surfaces, each of said second member locking surfaces disposed at an acute angle with respect to one of said second member contact surfaces; and
a compression member accommodating the fastener and configured to be axially disposed in a contacting relationship with the first member.

2. The device of claim 1, in which the compression member is dimensioned to be concentrically disposed within the second member.

3. The device of claim 1, the second member further comprising a plurality of extensions, each of said extensions comprising one of said second member contact surfaces and one of said member locking surfaces.

4. The device of claim 3, the second member further comprising a ring element in mechanical communication with each of the plurality of second member contact surfaces and with each of the plurality of second member locking surfaces.

5. The device of claim 4, the second member further comprising a plurality of extensions extending from the ring element, each of said extensions displaying one of said plurality of second member contact surfaces and one of said member locking surfaces.

6. The device of claim 5, in which each of said plurality of extensions extends generally orthogonally from the ring element.

7. The device of claim 6, each of the plurality of extensions comprising a lip, each said lip displaying one of the second member contact surfaces and one of the second member locking surfaces.

8. The device of claim 7, in which each of the plurality of lips extend inwardly from one of the extensions.

9. The device of claim 6, the first member further comprising an upper surface and a lower surface, said upper surface or said lower surface comprising a raised portion.

10. The device of claim 6, the compression member further comprising an upper surface and a lower surface, said upper surface or said lower surface comprising a raised portion.

11. The device of claim 6, in which the first member contact surface is axially aligned with each of the plurality of second member contact surfaces.

12. The device of claim 11, in which the first member locking surface is in abutting contact with each of the plurality of second member locking surfaces when the fastener is disposed in the first member, compression ring and second member and when a predesignated torque level has been applied to the fastener.

13. The device of claim 12, the first member comprising a first cylindrical element and a second cylindrical element, the second member cylindrical element axially depending from the first member cylindrical element and displaying said second member contact surface and said second member locking surface.

14. The device of claim 13, the first cylindrical element comprising a first circumferential portion and a second circumferential portion, the first circumferential portion having a lesser thickness than the second circumferential portion.

15. The device of claim 13, the first cylindrical element displaying a notch.

16. The device of claim 15, the notch extending from an outer surface of the first cylindrical element.

17. The device of claim 16, the notch disposed proximate a junction of the first cylindrical element and the second cylindrical element.

18. The device of claim 13, further comprising a cap disposable in the first member first cylindrical element.
